(19) United States
(12) Patent Application Publication
(10) Pub. No.: US 2026/0245430 A1
(43) Pub. Date: Aug. 20, 2026

(54) GEOFENCING SYSTEMS AND METHODS FOR ELECTRONIC TICKET BASED GAMING

(71) Applicant: Aristocrat Technologies, Inc., Las Vegas, NV (US)

(72) Inventors: Robert Butler, Austin, TX (US); Joseph Masinter, II, Las Vegas, NV (US); Scott Burns, Knoxville, TN (US); Alisa Mirabal, Henderson, NV (US); Lauralyn Sandoval, Las Vegas, NV (US); Robert Schramer, III, Las Vegas, NV (US)

(21) Appl. No.: 19/462,562

(22) Filed: Jan. 28, 2026

Related U.S. Application Data
(60) Provisional application No. 63/758,775, filed on Feb. 14, 2025.
(60) Provisional application No. 63/758,559, filed on Feb. 14, 2025.

(51) Int. Cl. G07F 17/32

(52) U.S. Cl. CPC G07F 17/3237; G07F 17/3251

(57) ABSTRACT

An electronic gaming system is provided. The electronic gaming system may include at least one memory storing geofence data defining at least one geofence and at least one processor that may be programmed to generate one or more electronic gameplay tickets associated with an electronic game, each of the one or more electronic gameplay tickets associated with a randomly determined outcome, in response to determining that a first device is located within the at least one geofence, enable the first device to request at least a first ticket of the one or more electronic gameplay tickets, and in response to the request, transmit at least one of the one or more electronic gameplay tickets to the first device, wherein the first ticket, when received by the first device, enables the first device to reveal the randomly determined outcome associated with the first ticket.

### CROSS-REFERENCE TO RELATED APPLICATIONS

This application claims the benefit of priority to U.S. Provisional Patent Application No. 63/758,559, filed February 14, 2025, and entitled “ELECTRONIC GAMING SYSTEMS AND METHODS USING ALTERNATIVE RANDOMNESS GENERATORS,” and U.S. Provisional Patent Application No. 63/758,775, filed February 14, 2025, and entitled “ELECTRONIC GAMING ENVIRONMENTS AND METHODS FOR ELECTRONIC GAMING IN ENVIRONMENTS,” the entire contents and disclosures of each of which are hereby incorporated herein by reference in their entirety.

### TECHNICAL FIELD

The field of disclosure relates generally to electronic gaming, and more specifically, to geofencing systems and methods for electronic ticket based gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is provided. The electronic gaming system may include at least one memory and at least one processor in communication with the at least one memory. The at least one memory may store geofence data defining at least one geofence. The at least one processor may be programmed to: (1) generate one or more electronic gameplay tickets associated with an electronic game, each of the one or more electronic gameplay tickets associated with a randomly determined outcome; (2) in response to determining that a first device is located within the at least one geofence, enable the first device to request at least a first ticket of the one or more electronic gameplay tickets; (3) in response to the request, transmit at least one of the one or more electronic gameplay tickets to the first device, wherein the first ticket, when received by the first device, enables the first device to reveal the randomly determined outcome associated with the first ticket; (4) in response to detecting that the randomly determined outcome associated with the first ticket has been revealed by the first device, identify an award amount associated with the randomly determined outcome; and (5) transfer the award amount to a credit balance associated with the first device.

In another aspect, a method for electronic gaming is provided. The method may be performed by a system including at least one memory and at least one processor in communication with the at least one memory. The at least one memory may store geofence data defining at least one geofence. The method may include: (1) generating one or more electronic gameplay tickets associated with an electronic game, each of the one or more electronic gameplay tickets associated with a randomly determined outcome; (2) in response to determining that a first device is located within the at least one geofence, enabling the first device to request at least a first ticket of the one or more electronic gameplay tickets; (3) in response to the request, transmitting at least one of the one or more electronic gameplay tickets to the first device, wherein the first ticket, when received by the first device, enables the first device to reveal the randomly determined outcome associated with the first ticket; (4) in response to detecting that the randomly determined outcome associated with the first ticket has been revealed by the first device, identifying an award amount associated with the randomly determined outcome; and (5) transferring the award amount to a credit balance associated with the first device.

In a further aspect, at least one non-transitory computer-readable storage media having computer-executable instructions embodied thereon is provided. When executed by at least one processor in communication with at least one memory, the at least one memory storing geofence data defining at least one geofence, the computer-executable instructions may cause the at least one processor to: (1) generate one or more electronic gameplay tickets associated with an electronic game, each of the one or more electronic gameplay tickets associated with a randomly determined outcome; (2) in response to determining that a first device is located within the at least one geofence, enable the first device to request at least a first ticket of the one or more electronic gameplay tickets; (3) in response to the request, transmit at least one of the one or more electronic gameplay tickets to the first device, wherein the first ticket, when received by the first device, enables the first device to reveal the randomly determined outcome associated with the first ticket; (4) in response to detecting that the randomly determined outcome associated with the first ticket has been revealed by the first device, identify an award amount associated with the randomly determined outcome; and (5) transfer the award amount to a credit balance associated with the first device.

In another aspect, an electronic gaming environment for electronic gaming that includes: at least one geofence defining an area; at least one point of sale device located within the at least one geofence, the at least one point of sale device outputting a single gameplay ticket associated with at least one electronic game; and a server in communication with the at least one point of sale device, the server controlling the electronic game by allowing at least one user located within the at least one geofence to at least one of: purchase the single gameplay ticket; reveal an outcome for the at least one electronic game associated with the single gameplay ticket; collect awarded prize values from the at least one point of sale device in response to determining the outcome of the at least one electronic game is a winning game; transfer the awarded prize values to an account; or transfer the at least one electronic game associated with the single gameplay ticket to a distinct user.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an illustration of a user purchasing a gameplay ticket for electronic games at a participating store.

FIG. 5 is a screenshot of a monitor for the electronic games displayed at the participating store of FIG. 4.

FIG. 6 is an illustration of a purchased gameplay ticket for electronic games.

FIG. 7 is an illustration of a user scanning the purchased gameplay ticket of FIG. 6.

FIGS. 8 and 9 are illustrations of an electronic device and an app used to play the electronic games associated with the gameplay ticket.

FIGS. 10-12 are illustrations of the electronic device and the app playing the electronic games associated with the gameplay ticket of FIG. 6.

FIGS. 13 and 14 are illustrations of the user collecting awarded prizes for the electronic games at the participating store.

FIGS. 15 and 16 are illustrations of a user purchasing a gameplay ticket for electronic games at a participating kiosk.

FIG. 17 is an illustration of an electronic device and app included therein for allowing a user to purchase electronic games directly on the electronic device.

FIG. 18 is an illustration of a user purchasing a gameplay ticket for a future electronic game at a participating kiosk.

FIGS. 19 and 20 are illustrations of multiple electronic devices and a user player the future electronic game of FIG. 18.

FIG. 21 is an illustration of an electronic device and app included therein for allowing a user to transfer awarded prize values to a casino loyalty club within the app.

FIG. 22 is an illustration of an electronic device and app included therein for allowing a user to transfer electronic games to a distinct user.

FIG. 23 is an example flow diagram presenting a method of playing various electronic games associated with a gameplay ticket and app.

FIG. 24 is an illustration of an environment for playing the electronic games of FIGS. 4-23.

FIGS. 25-27 are illustrations of various environments for playing the electronic games of FIGS. 4-23.

FIG. 28 is a flowchart illustrating an exemplary method for electronic gaming that may be performed using any of the exemplary environments illustrated in FIGS. 24-27.

### DETAILED DESCRIPTION

Based on laws, regulations, and gaming commission rules, members of the public who are of eligible age are free to visit established gaming facilities (e.g., casinos), to play games. The games offer players the opportunity to win prizes and/or awards (e.g., money) while located within the established gaming facilities. In exemplary embodiments, these laws, regulations, and gaming rules are not limited to facilities themselves, but are regulations for entire, predefined land areas. For example, tribal lands apportioned to and/or controlled by Indigenous people of the United States are governed by additional and/or distinct rules, which includes the ability to administer a variety of wagering games. As such, players located within the predefined land areas designated as tribal lands would be able to legally purchase, play, transfer, and/or collect wagering games anywhere within the tribal land.

The present disclosure discussed herein transforms today’s Class II type gaming (e.g., bingo systems), which is capable of being played within tribal lands for example, to support electronic and/or mobile gaming. That is, the present disclosure provides systems and methods of purchasing, playing, transferring, and/or collecting awarded winnings of electronic games and/or games capable of being played on electronic devices (e.g., mobile devices, tablets, computers, etc.). The electronic and/or mobile games can be at least purchased, played, transferred to other players, and/or have winnings collected while the player of the electronic games is located within the predefined land areas (e.g., tribal lands). The present disclosure also provides different locations and/or opportunities for players to purchase and/or play these electronic and/or mobile games. For instance, players can purchase gameplay tickets from various participating places of business (e.g., casinos, stores, etc.) located within tribal lands, kiosks or automated vendors within the tribal land, and/or using an “App” installed on a player’s electronic device while the player is located on tribal lands.

The present disclosure provides, for example, electronic and/or mobile games that include eInstant scratch-off games and/or eFuture bingo based games that are played on electronic devices. For an eInstant scratch-off game, the Class II type system would need a new verification and redemption process for winnings that does not exist in the today’s class II slot games. For example, the system would need to: (1) allow for a variety of redemption mechanisms (e.g., email), (2) allow operators or administrators of the electronic games (e.g., eInstant scratch-off games) to manage certain winning redemption restrictions (e.g., where a player can redeem the ticket), (3) perform age checks and player verification, (4) manage tribal reimbursement, and/or (5) winning thresholds. Other use cases include: (1) how the system handles the transfer of “unscratched” or “scratched off” game tickets to an eligible player and (2) where such transfers can occur (e.g., only on tribal lands, off tribal lands, between participating tribal lands).

For eFuture Bingo Based Games (eFBBG), operators or administrators of the eFBBG exposes the game result later at a predefined set date and/or time. For award prizes associated with results, the system would be configured to provide single-site and/or multi-site jackpots. The jackpots can expand across different operators (e.g., multiple tribes or tribal lands), different U.S. states, and/or different countries. The systems and methods provided can also be configured as an omnichannel wide area progressive (WAP) that is across game types (e.g., class II, class III, iGaming). In one implementation, the system could use separate class II servers for specific eInstant scratch-off games and eFBBG.

The systems and methods described herein include an electronic gaming environment for electronic gaming. The electronic gaming environment comprises at least one geofence area that defines a location area; at least one point of sale device located within the at least one geofence area wherein the at least one point of sale device outputs a single gameplay ticket is associated with at least one electronic game; and a server in communication with the at least one point of sale device, wherein the server controls the electronic game by allowing at least one user located within the at least one geofence area to at least one of: (i) purchase the single gameplay ticket (ii) reveal an outcome for the at least one electronic game associated with the single gameplay ticket; (iii) collect awarded prize values from the at least one point of sale in response to determining the outcome of the at least one electronic game is a winning game; (iv) transfer the awarded prize values to an account such as a bank account; or (v) transfer the at least one electronic game associated with the single gameplay ticket to a distinct user.

The electronic gaming environment as described above may further include the at least one point of sale device being located at or associated with at least one a casino, a store, a kiosk, or a user’s personal electronic device including an application executing thereon.

The electronic gaming environment as described above may further include the at least one point of sale device being located at or associated with a first casino and a second casino, wherein each of the first casino and the second casino is in communication with the server.

The electronic gaming environment as described above may further include the at least one geofence area being a first geofence area and a distinct, second geofence area, wherein the first casino is located within the first geofence area.

The electronic gaming environment as described above may further include the second casino is located in one of the first geofence area or the second geofence area.

The electronic gaming environment as described above may further include the server controlling the electronic gaming by allowing at least one user located outside of the at least one geofence area to at least one of: purchase the single gameplay ticket; reveal the outcome for the at least one electronic game associated with the single gameplay ticket; collect awarded prize values from the at least one point of sale device in response to determining the outcome of the at least one electronic game is a winning game; transfer the awarded prize values to a bank account; or transfer the at least one electronic game associated with the single gameplay ticket to a distinct user.

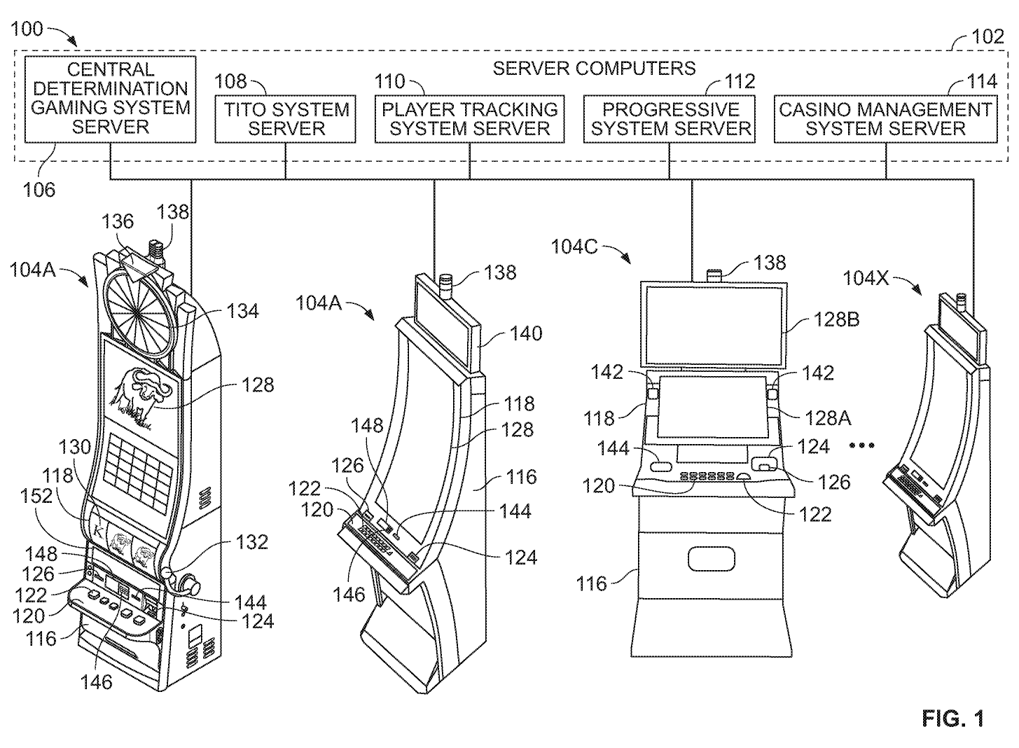

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL^{TM} model gaming device manufactured by Aristocrat^{®} Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate gameplay.

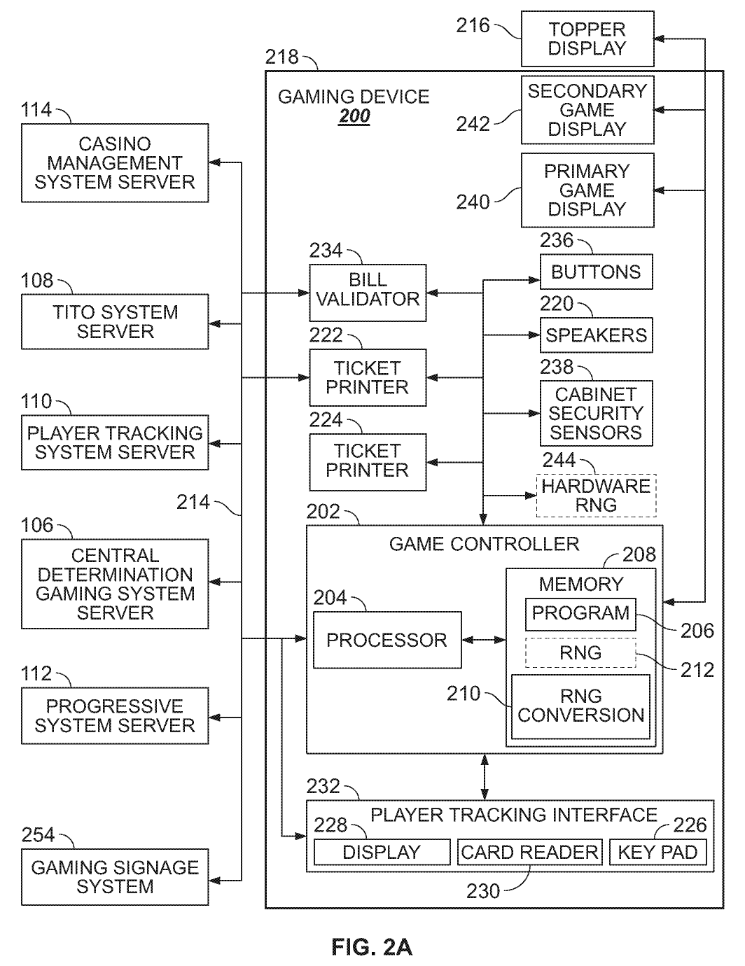

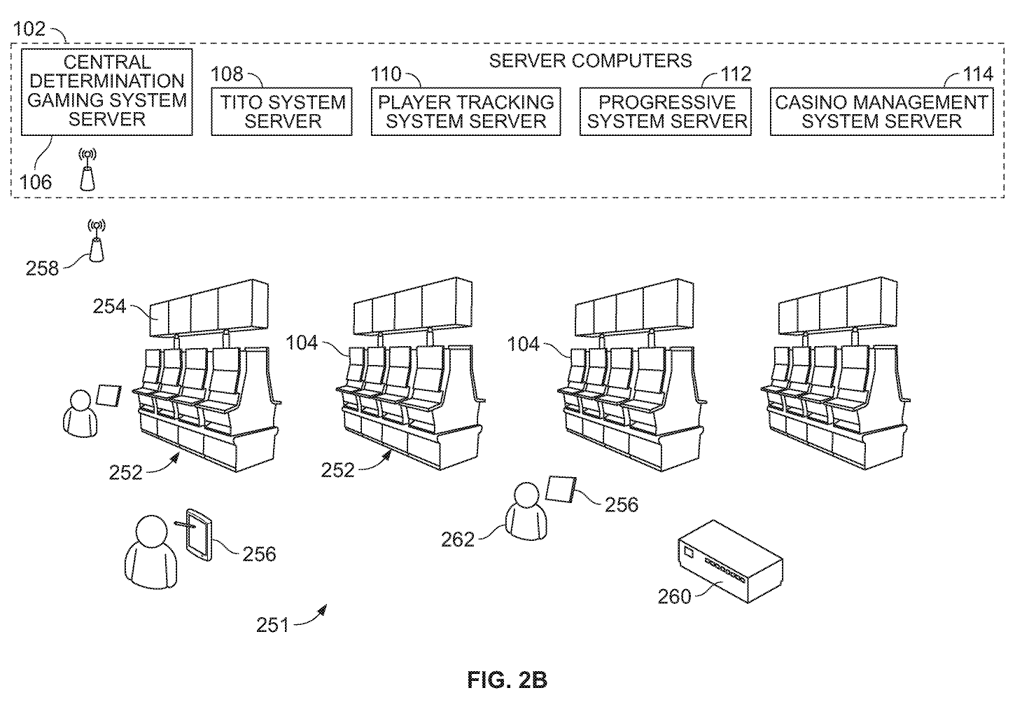

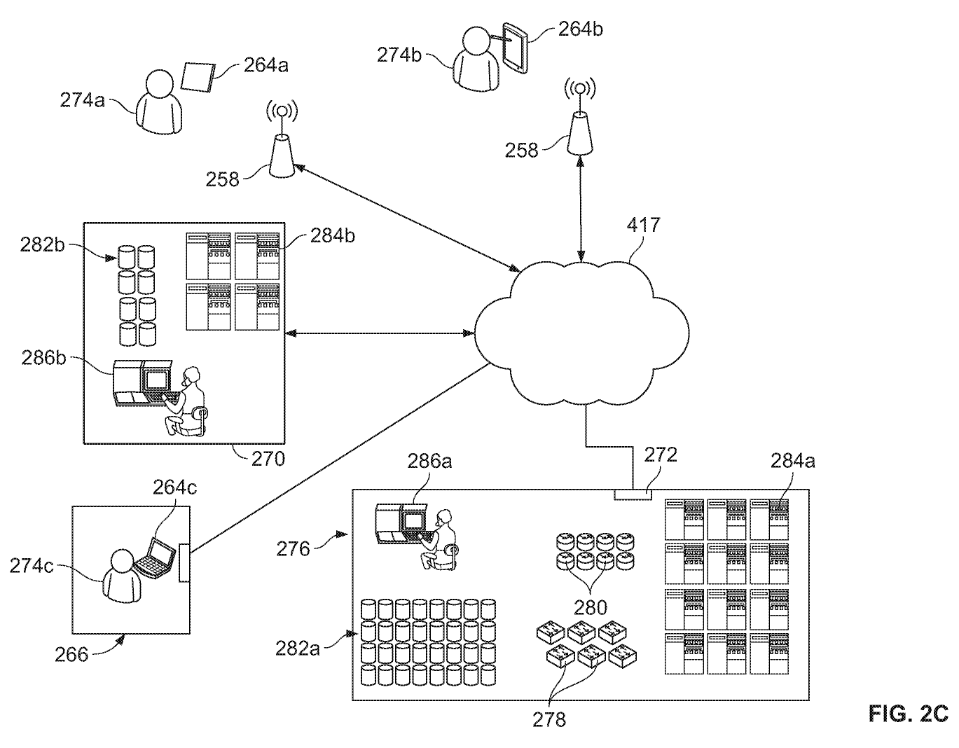

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc^{TM} model gaming device manufactured by Aristocrat^{®} Technologies, Inc. Note that where possible, reference numerals identifying similar features of the gaming device 104A implementation are also identified in the gaming device 104B implementation using the same reference numbers. Gaming device 104B does not include physical reels and instead shows gameplay functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat^{®} Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary gameplay while secondary display 128B is typically used for bonus gameplay, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value, a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS^{®} system manufactured by Aristocrat^{®} Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of gameplays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of gameplay (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online gameplay. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player’s EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online gameplay, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

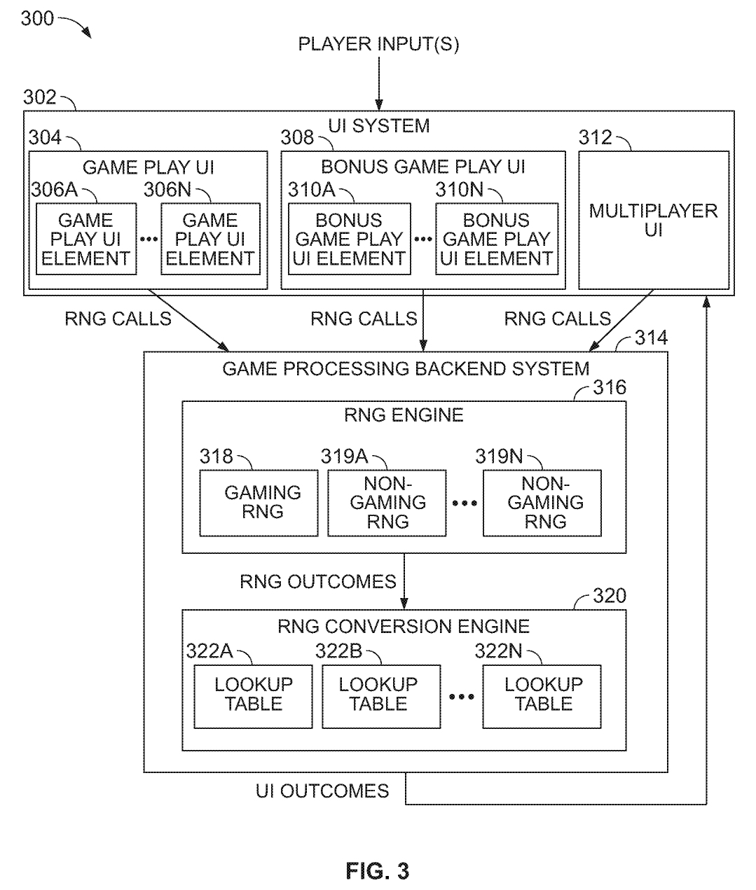

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more gameplay UIs 304, one or more bonus gameplay UIs 308, and one or more multiplayer UIs 312, where each UI type includes one or more mechanical UIs and/or graphical UIs (GUIs). In other words, gameplay UI 304, bonus gameplay UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present gameplay to a player. Using FIG. 3 as an example, the different UI elements are shown as gameplay UI elements 306A-306N and bonus gameplay UI elements 310A-310N.

The gameplay UI 304 represents a UI that a player typically interfaces with for a base game. During a game instance of a base game, the gameplay UI elements 306A-306N (e.g., GUI elements depicting one or more virtual reels) are shown and/or made available to a user. In a subsequent game instance, the UI system 302 could transition out of the base game to one or more bonus games. The bonus gameplay UI 308 represents a UI that utilizes bonus gameplay UI elements 310A-310N for a player to interact with and/or view during a bonus game. In one or more implementations, at least some of the gameplay UI element 306A-306N are similar to the bonus gameplay UI elements 310A-310N. In other implementations, the gameplay UI element 306A-306N can differ from the bonus gameplay UI elements 310A-310N.

FIG. 3 also illustrates that UI system 302 could include a multiplayer UI 312 purposed for gameplay that differs or is separate from the typical base game. For example, multiplayer UI 312 could be set up to receive player inputs and/or presents gameplay information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament gameplay. After tournament gameplay ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for gameplay. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more gameplay UI elements 306A-306N, such as symbols, for the gameplay UI 304. In another example, if the UI outcome is for a bonus game, the UI system could update one or more bonus gameplay UI elements 310A-310N (e.g., symbols) for the bonus gameplay UI 308. In response to updating the appropriate UI, the player may subsequently provide additional player inputs to initiate a subsequent game instance that progresses through the game processing pipeline.

### Gameplay

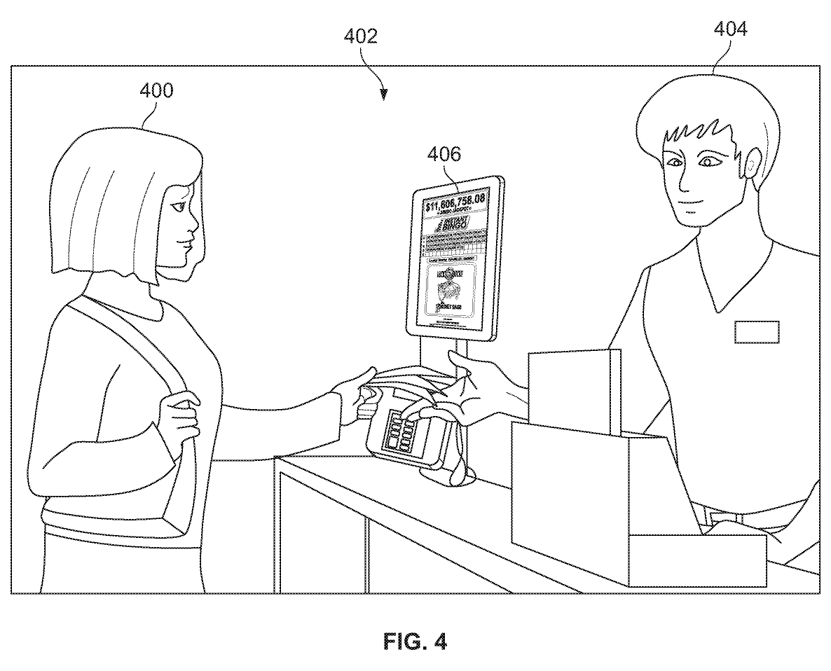

FIGS. 4-8 show exemplary views of a process of purchasing at least one ticket to participate in a game. In non-limiting examples, the game is configured as a class II type game. It is understood that the game can be any class II style game including, but not limited to, bingo games, historic horse racing, non-banked card games (e.g., 5-card stud poker), and/or any other suitable, alternative randomness generators for providing game results, as discussed herein. In other non-limiting examples, the game can be configured as a class III type game based on RNG, as discussed herein.

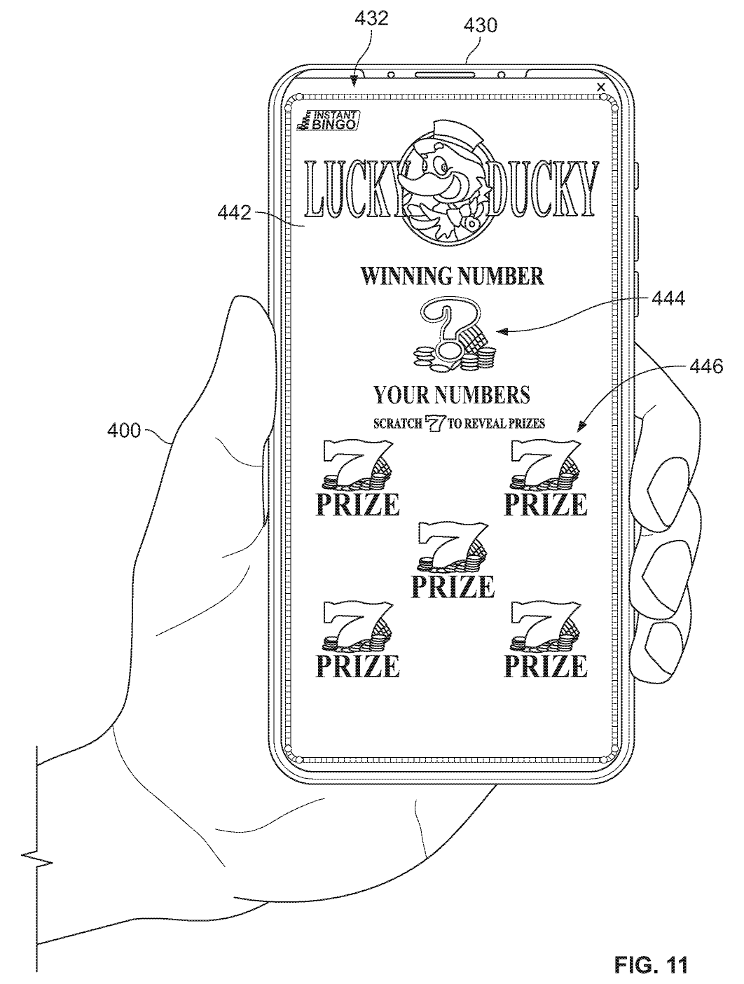

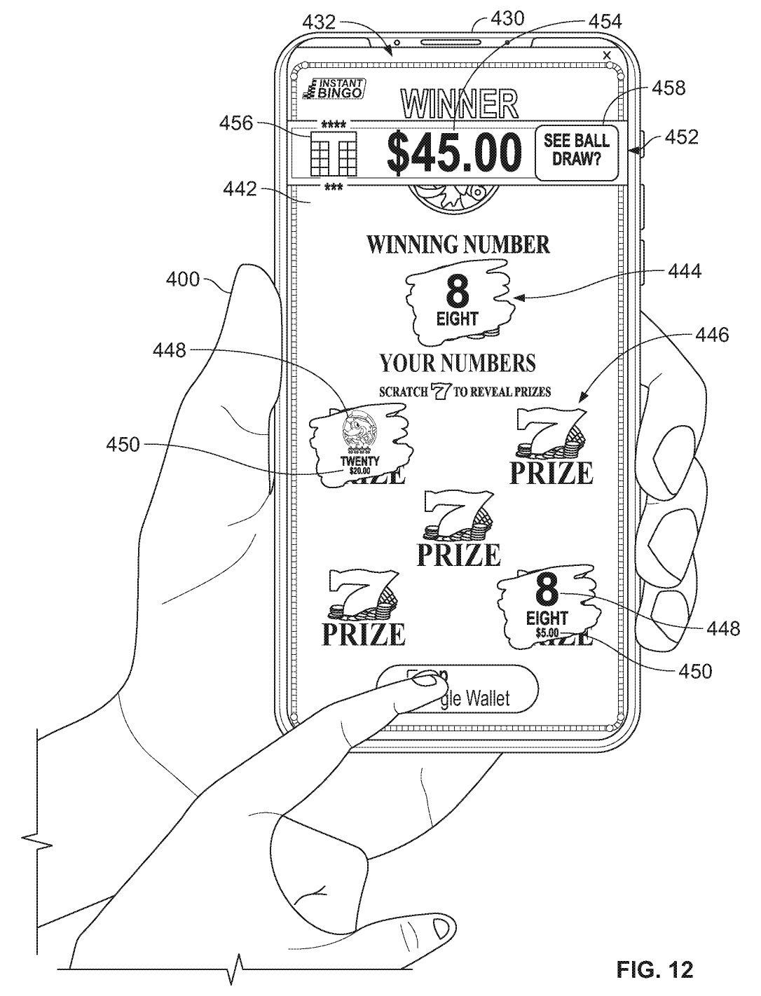

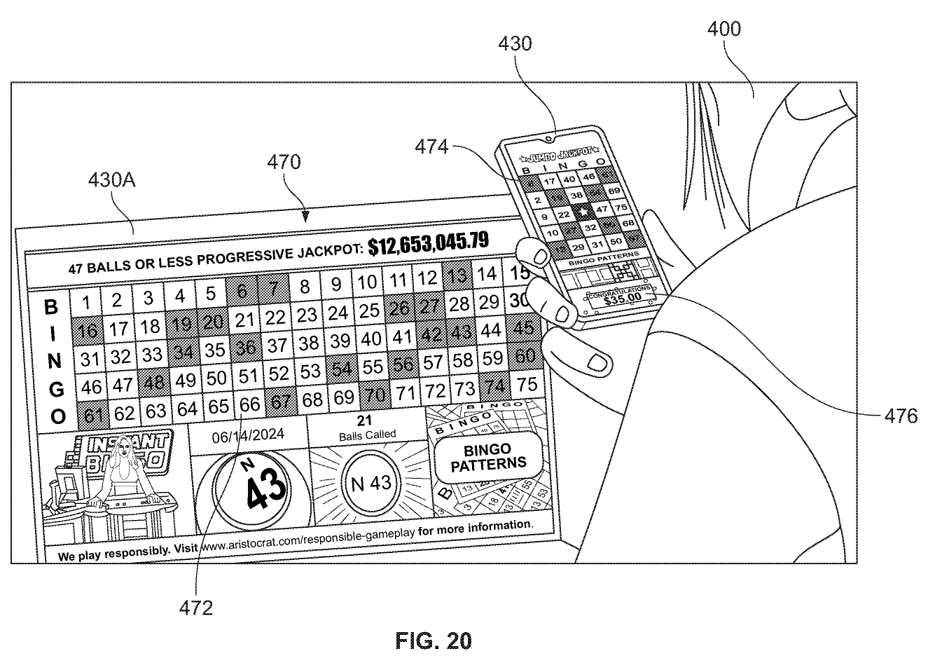

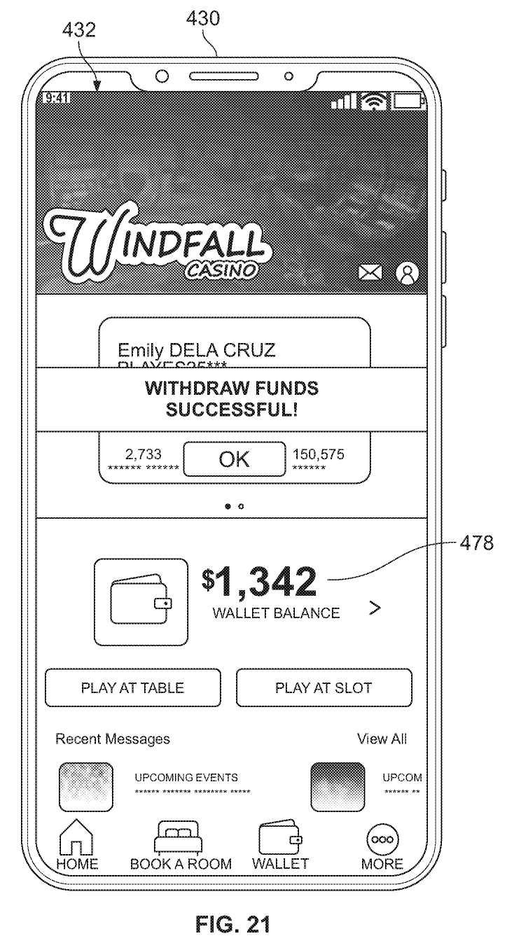

Games discussed herein include electronic games that are played, engaged, transferred, and/or otherwise interacted with on personal electronic devices including, but not limited to, mobile phones, tablets, laptop computers, desktop computers, or the like. Purchased game tickets, which initiate the games, can be purchased or accessed by players or users in various locations and/or directly on personal electronic devices, as discussed herein. Moreover, the electronic games discussed herein can be presented to the player or user in various forms and/or with a multitude of visual content. For example, the electronic games are presented as digital “scratch-offs” (see, FIGS. 11 and 12), a bingo card associated with a bingo drawing (see, FIGS. 20 and 21), a plurality of spinnable game reels, a spinnable prize wheel, or other any other interactive visual depiction of a game of chance. Although capable of being displayed as any variety of playable games, it is understood that that in exemplary embodiments, the gameplay and/or the results of the electronic game discussed herein are based on class II style gaming, such as bingo-type games, historic horse racing results, non-banked card games, and/or other alternative randomness generators configured to generate and provide random outcomes or results for determining and/or defining winning prize values for the electronic games.

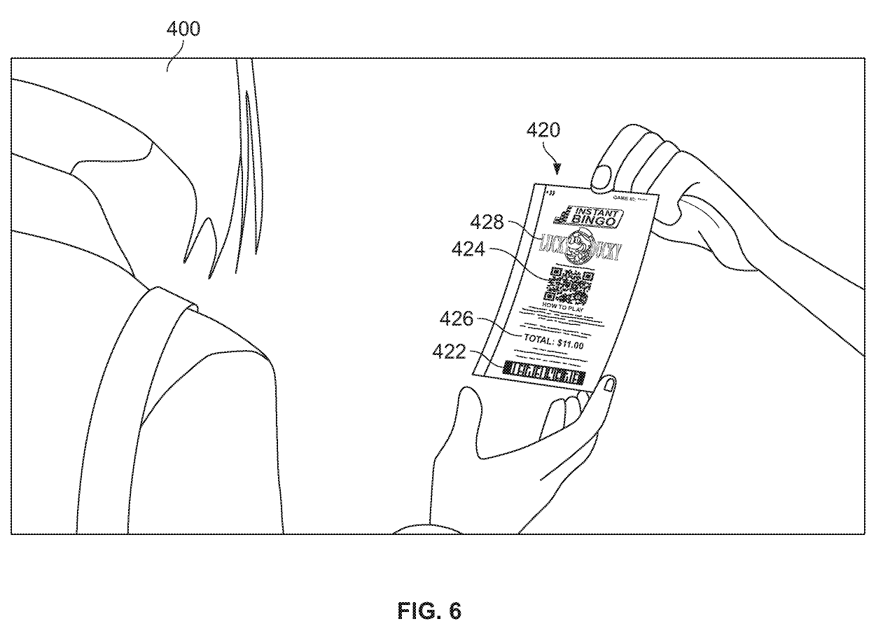

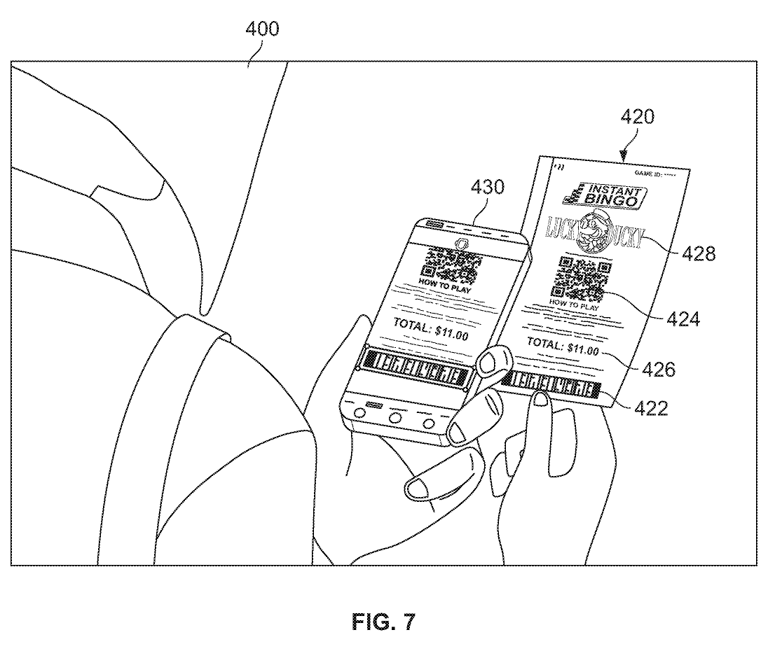

In order to participate, interact, and/or play the game discussed herein, a user or player must purchase a game slip or ticket. In the exemplary embodiment shown in FIGS. 4-6, a user or player 400 (hereafter, “user 400”) visit a brick-and-mortar store 402 (hereafter, “store 402”), such as a convenient store, a gas station, or the like, to purchase a gameplay ticket (see, FIG. 6). In the non-limiting example, the gameplay ticket can be purchased from a store attendant 404. At the time of purchase, attendant 404 can also verify that user 400 is eligible to purchase gameplay tickets by, for example, checking and/or verifying user’s age. Attendant 404 can verify user’s 400 age by inspecting and/or scanning an official government issued ID (e.g., license, passport). Alternatively, attendant 404 can scan a user specific QR code included in a gameplay app downloaded on a user’s 400 smart device or mobile device (see, FIG. 7). As discussed herein, the user specific QR code is only associated with user 400 and is generated and/or associated with user 400 after user 400 verifies personal information within the gameplay app and/or third-party identity verification services.

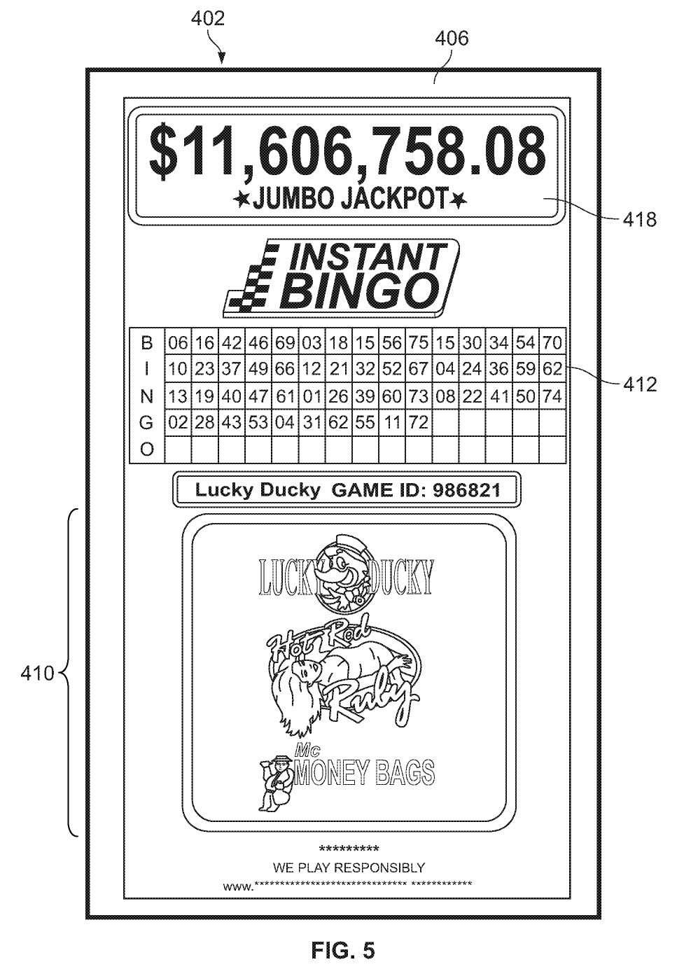

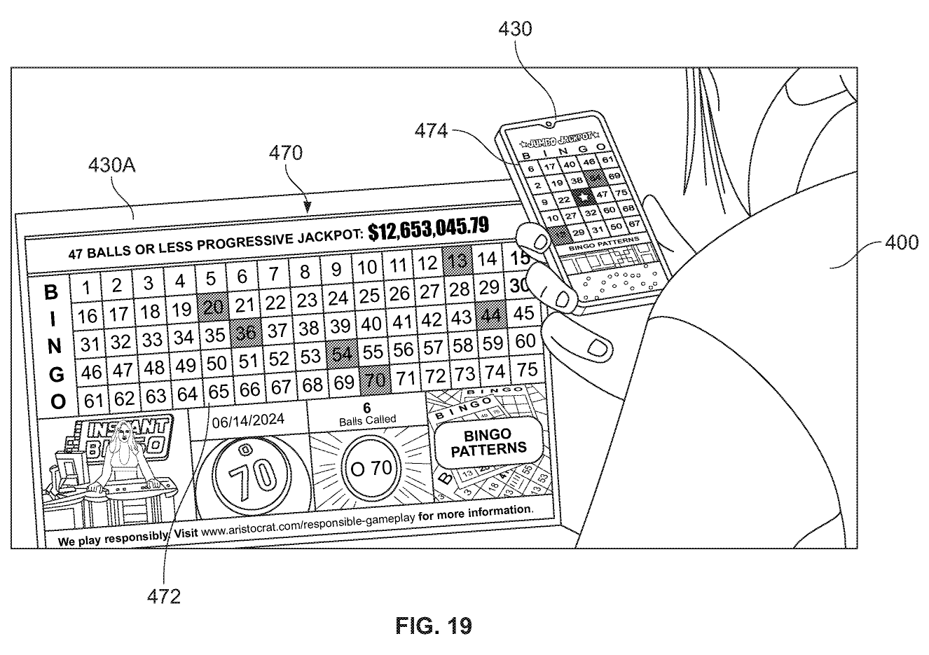

Additionally, as shown in FIG. 4, store 402 includes a gameplay monitor 406 specific to the game played by user 400 and/or associated with the gameplay ticket. FIG. 5 shows an exemplary embodiment of monitor 406 and the game content 408 displayed thereon. Game content 408 can include, for example, graphics 410 representing each of the various class II type game titles offered to user 400 (e.g., Lucky Ducky, Hot Red Ruby, Mr. Money Bags) as well as bingo ball call results 412. Bingo ball call results 412 includes live bingo results for a game currently being played, or alternatively, can be past results or randomly generated results displayed for visual effect. Moreover, bingo ball call results 412 displayed on monitor 406 can be generated by alternative randomness generators, as discussed herein. Additionally in the exemplary embodiment, monitor 406 can display a jackpot value 418 for a distinct, future game 470, as discussed herein (see, FIGS. 19-21).

Turning to FIG. 6, and subsequent to user verification, user 400 purchases and is provided a gameplay ticket 420 from attendant 404. In exemplary embodiments, a single, gameplay ticket 420 is provided to user 400 regardless of the number of plays user 400 purchases and/or regardless of whether user 400 purchases plays for a single game title or multiple game titles (e.g., game content 408). That is, whether user 400 purchases a single play for a single game, multiple plays for a single game, a single play for multiple game titles, or multiple plays for multiple game titles, user 400 is provided with a single, gameplay ticket 420 upon purchase. As shown in FIG. 6, gameplay ticket 420 includes a bar code 422, a QR code 424, a total value or purchase cost 426, and a graphic(s) 428 representing at least one of the game titles for games user 400 purchased in the transaction. As discussed herein, bar code 422 of gameplay ticket 420 facilitates user’s 400 ability to load, link, activate, and/or otherwise play the games purchased at store 402 and associated with gameplay ticket 420 on a user’s electronic device (see, FIG. 7). Additionally, and as discussed herein, QR code 424 of gameplay ticket 420 is used for verification purposes when paying out any awarded prizes, cash values, or the like, associated with gameplay ticket 420. Alternatively, QR code 424 facilitates user’s 400 ability to play the purchase games, while bar code 422 is used for verification purposes, as discussed herein. In another exemplary embodiment, bar code 422 facilitates user’s 400 ability to both play the purchased games as well as verify winnings and payouts, as discussed herein, while QR code 424 can be, for example, linked to a URL or a device app store for downloading an app to play the purchase games, as discussed herein.

In order to load, activate, interact, and/or play the purchased games associated with gameplay ticket 420, user 400 scans bar code 422 (and/or QR code 424) on gameplay ticket 420. In the exemplary embodiment shown in FIG. 7, user 400 utilizes an electronic device 430 to scan and/or interact with ticket 420. For example, user 400 utilizes the camera on their mobile phone (e.g., electronic device 430) to capture an image of and/or scan bar code 422 (and/or QR code 424) on gameplay ticket 420 to load, activate, interact, and/or play the purchased games associated with gameplay ticket 420. Electronic device 430 can be formed as any suitable personal electronic device 430 including, but not limited to, a mobile phone, a tablet, a laptop computer, or the like.

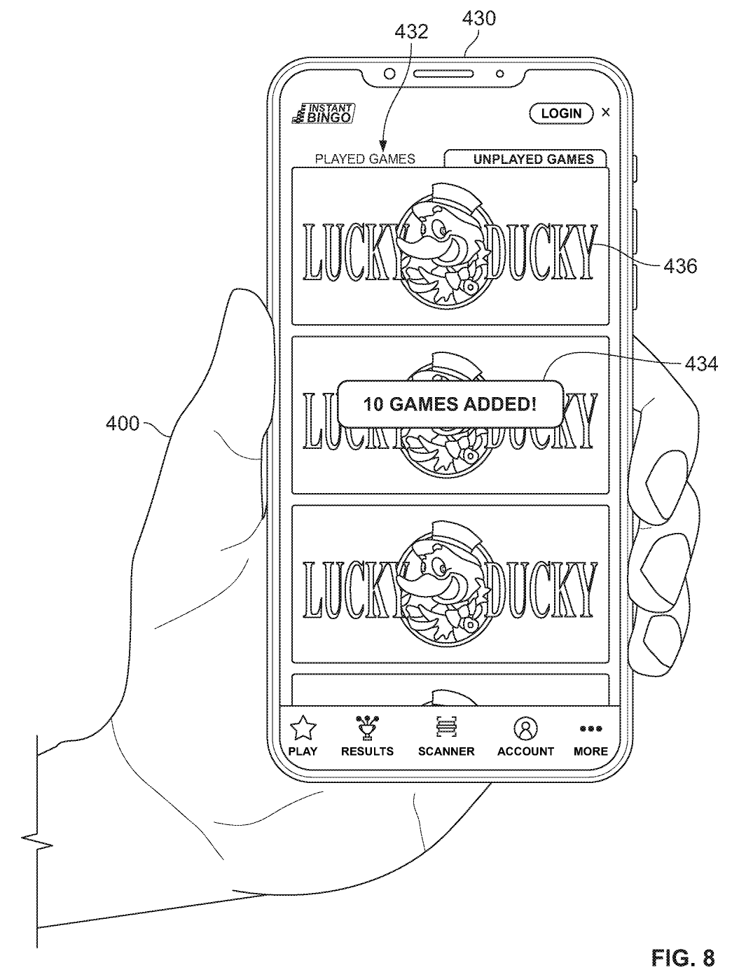

Subsequent to loading, activating, scanning, and/or capturing an image of bar code 422 (and/or QR code 424) on gameplay ticket 420, electronic device 430 can load and/or present the purchased games to user 400. In an exemplary embodiment shown in FIG. 8, scanning bar code 422 (and/or QR code 424) opens an app 432 on electronic device 430 and presents or visually displays the purchased games to user 400 thereon. As shown in FIG. 8, app 432 included on electronic device 430 displays a notification banner or message 434 indicating to user 400 how many games have been “added” or are now playable (e.g., “10 games added!”) based on the purchase and scanning of gameplay ticket 420. Additionally, graphics or icons 436 of the purchase games associated with gameplay ticket 420 are also displayed in app 432 subsequent to the scanning and/or interacting with gameplay ticket 420.

Although discussed herein as being presented on app 432, it is to be understood that the purchased games associated with gameplay ticket 420 may also be presented and/or displayed on a web browser of electronic device 430. In the non-limiting example where purchased games are presented on a web browser, user 400 may undergo an additional round of age verification (e.g., scroll down options) before the web browser of electronic device 430 displays and/or allows user 400 to play or interact with the purchased games.

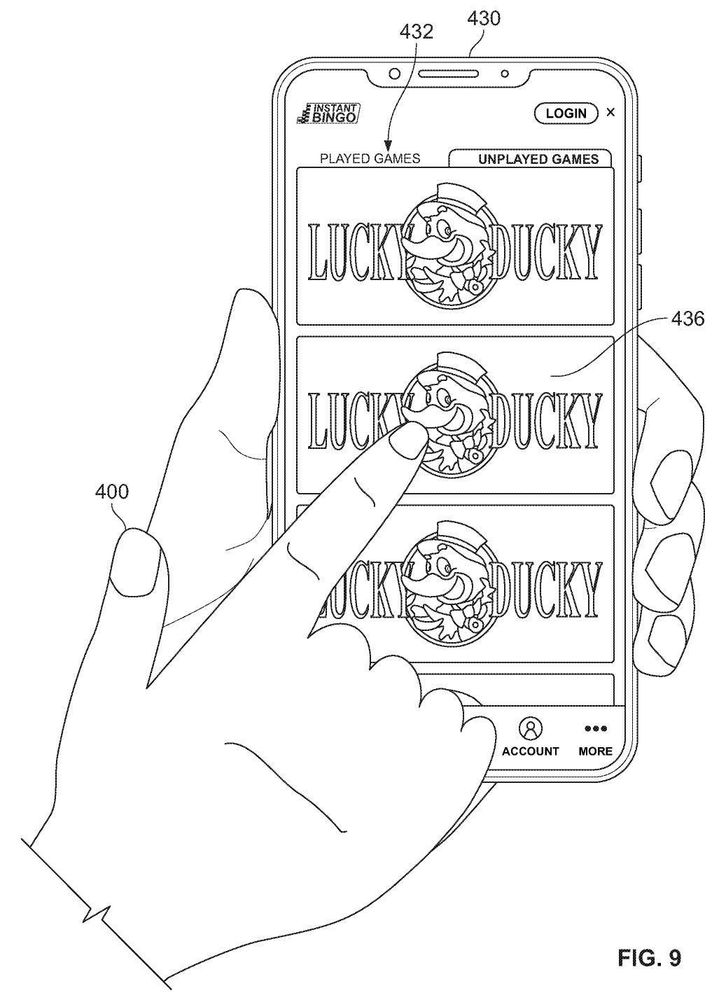

FIGS. 9-12 show exemplary screenshots of electronic device 430 while user 400 plays one of the purchased games using gameplay ticket 420. It is to be understood that similarly numbered and/or named components may function in a substantially similar fashion. Redundant explanation of these components has been omitted for clarity.

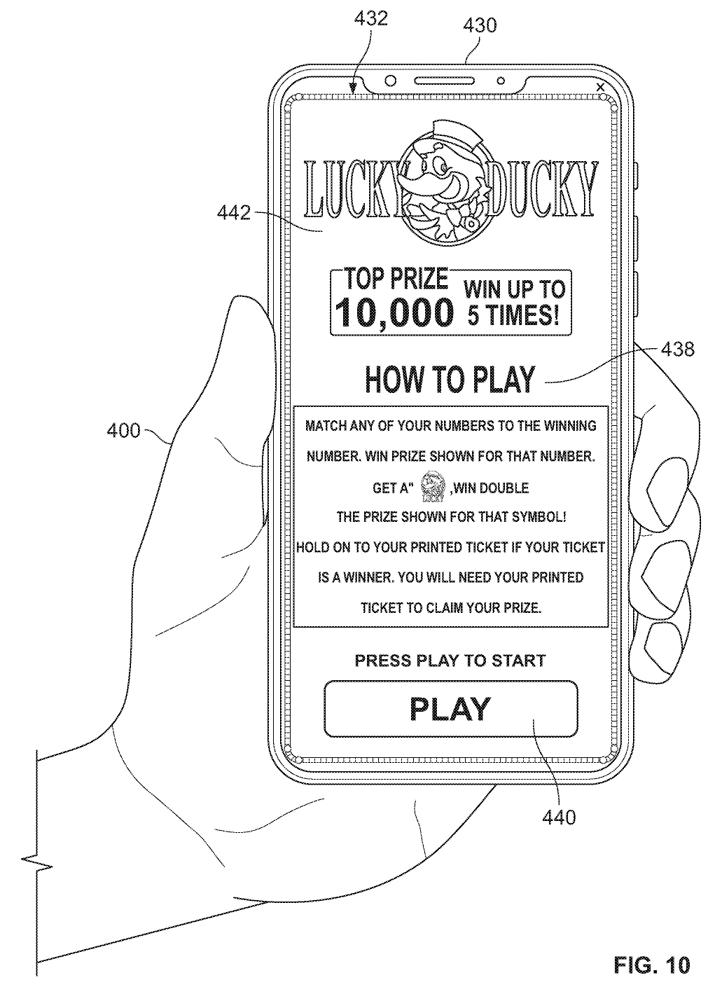

As shown in FIG. 9, user 400 can tap or touch icon 436 displayed on electronic device 430 to interact, and more specifically begin playing one of the games purchased and associated with gameplay ticket 420. In exemplary embodiments, app 432 included on electronic device 430 displays rules or game instructions 438 subsequent to the interaction with icon 436, as shown in FIG. 10. Game instructions 438 let user 400 know how to play the purchase games, and/or how to identify winning games. Additionally, app 432 of electronic device 430 includes a play button 440, which when tapped or touched, triggers the displaying of the purchased game.

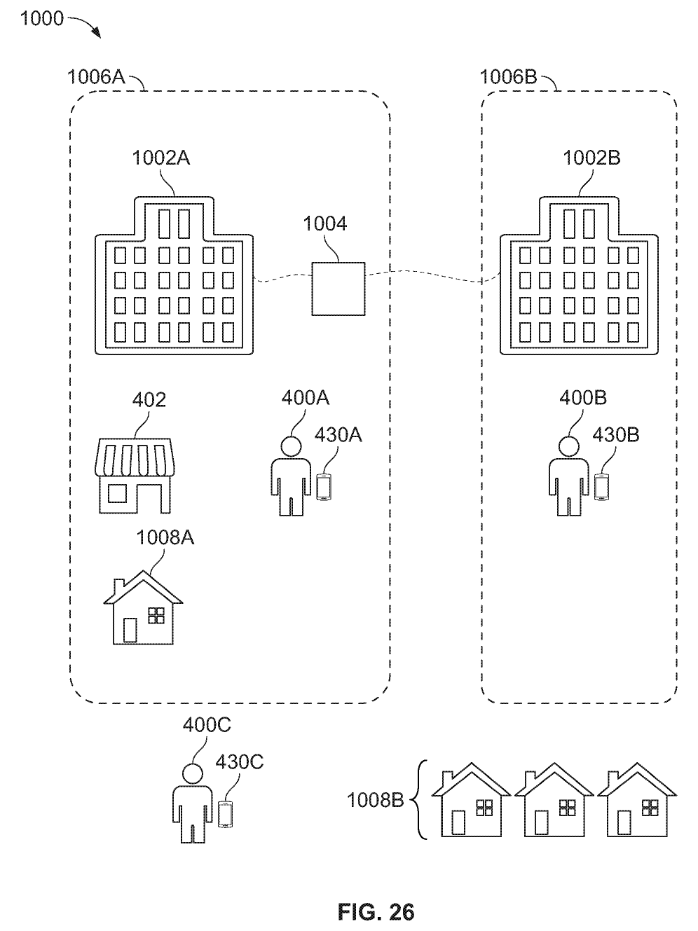

As discussed herein, purchased games associated with gameplay ticket 420 and displayed and/or interacted with on electronic device 430 are class II type games (e.g., bingo games, historical horse racing, non-banked card games, alternative randomness generators). As a result, and in order to determine whether user 400 is a winner and/or the played game is awarded a prize or winning value, a ball call (e.g., game result) must be performed by the gaming system and/or server (see, FIG. 26) linked to the purchased game. The ball call results are then compared to a bingo card associated with the purchased game(s). In non-limiting examples, each purchased game includes a distinct bingo card, and each game requires a distinct ball call to determine if the purchased game played by user 400 on electronic device 430 is a winning game. In other non-limiting examples, each purchased game includes a distinct bingo card, which are compared to a single ball call to determine if the purchased game played by user 400 on electronic device 430 is a winning game. In additional non-limiting examples, each purchased game is associated with a single bingo card, and each game requires a distinct ball call to determine if the purchased game played is a winning game.

In an exemplary embodiment, bingo card(s) and/or ball calls associated with the purchased games are assigned and/or linked to the purchased games at the time gameplay ticket 420 is purchased by user 400. In another non-limiting example, bingo card(s) and/or ball calls associated with the purchased games are assigned and/or linked to the purchased games at the time gameplay ticket 420 is scanned by electronic device 430, or alternatively, when user 400 engages icons 436 and game instructions 438 are displayed within app 432 on electronic device 430, or when user 400 touches play button 440.

Furthermore, the ball calls or game results generated for the purchased games are generated in real-time at the time of purchase or when interacting with the purchased game (e.g., displaying game instructions 438). These game results may be referred to herein as “present game” results or “present ball calls.” In other non-limiting examples, ball calls or game results for the purchased games may include at least one previous or historic ball call stored on and/or recalled by the server or system for the purchased electronic games. When playing a class II type bingo game, ball calls cannot be generated if only a single player or user is playing that class II type game. Because the game of bingo requires at least two distinct players, multiple players, and/or multiple bingo cards are required in order to generate a ball call. In an exemplary embodiment, where user 400 is the only player for class II type game associated with gameplay ticket 420 (e.g., purchase gameplay ticket 420 at 3:00 AM), instead of generating present ball calls, the server or system can compare the bingo card associated with user’s 400 purchased games with at least one past or previously generated ball call. The previously generated ball call includes a game that had more than one player or user/bingo card. Comparing the bingo card associated with the purchased games to the previously generated ball call in turn determines if the purchased game played is a winning game. The previously generated ball call may be referred to herein as “past game” results or “past ball calls.” In other non-limiting examples, the server or system controlling the games associated gameplay ticket 420 may utilize past ball calls when, for example, the real-time or present ball calls are not available and/or unable to be generated (e.g., system maintenance, software updates, offline/network outage, etc.).

In some examples, and as discussed herein, the results of the games associated with gameplay ticket 420 are predetermined, predefined, and/or delineated prior to user 400 engaging with the game. As such, the terms “play” or “playing” with reference to the games associated with gameplay ticket 420 (see, FIGS. 11 and 12) may similarly refer to user 400 interacting with electronic device 430 to “reveal” the results or outcome of the games. For example, where bingo card(s) and/or ball calls associated with the purchased games are assigned and/or linked to the purchased games at the time gameplay ticket 420 is purchased by user 400, the result or outcome of the game are similarly determined at the time of purchase. However, the results or outcome of the games associated with gameplay ticket 420 are hidden from user 400 until user 400 plays and/or interacts with the game to reveal these outcomes.

In the exemplary embodiment shown in FIG. 11, and subsequent to interacting with play button 440 (see, FIG. 10), a digital scratch-off game 442 is displayed on electronic device 430. That is, when user 400 engages and/or plays the purchased game(s) associated with gameplay ticket 420, digital scratch-off game 442 is displayed and/or presented to user 400 on electronic device 430. In non-limiting examples where user 400 is playing the game through app 432, digital scratch-off game 442 is displayed on electronic device 430 within app 432. In other non-limiting examples where purchased games are being displayed via a web browser, digital scratch-off game 442 is displayed directly through the web browser.

Digital scratch-off game 442 includes an identifiable winning number 444, as well as game or player numbers 446 (e.g., “Your Numbers”). In the non-limiting example shown in FIG. 11, only a single number is included in winning number 444, while player numbers 446 includes five (5) distinct numbers (unscratched or not revealed in FIG. 11). However, it is to be understood that digital scratch-off game 442 associated with gameplay ticket 420 can include any number of winning numbers 444 and/or player numbers 446. Moreover, and as discussed herein, the game associated with gameplay ticket 420 is not limited to a “scratch off” style game. Rather, the digital or electronic game presented to user 400 on electronic device 430 can include a bingo card and bingo ball call (e.g., present ball call or past ball call), a plurality of spinnable game reels, a spinnable prize wheel, or other any other interactive visual depiction of a game or game of chance. What is common among all these various game types is that the outcome is determined based on the game of bingo.

User 400 may then “scratch” (e.g., tap or move finger over) electronic device 430 to reveal symbols 448 (e.g., numbers, icons) associated with the purchased game. For example, and as shown in FIG. 12, revealed symbol 448 for winning number 444 include and/or display “8”, and revealed symbols 448 for player numbers 446 include and/or display a game-associated icon, “5,” “7,” “9,” and “8.” Underneath the game associated icon and symbol 448 including “8” are also prize values 450. More specifically, below symbol 448 including the game-associated icon a “$20.00” prize values 450 is shown, while below symbol 448 including “8” a “$5.00” prize values 450 is shown. Prize values 450 indicate to user 400 that they have won.

Additionally as shown in FIG. 12 a prize banner 452 is displayed and/or depicted on electronic device 430. More specifically, subsequent to the playing of digital scratch-off game 442 and determining digital scratch-off game 442 is a winning game, prize banner 452 is visually displayed on electronic device 430 for user 400. In the exemplary embodiment, prize banner 452 includes a total winning prize value 454 (e.g., $20.00 x 2 + $5.00), a bingo card pattern 456, and the ball call results 458. Bingo card pattern 456 corresponds to the bingo card assigned and/or associated with digital scratch-off game 442 at the time of purchase/play, as discussed herein. Furthermore, ball call results 458 is also the generated ball call that is assigned and/or associated with digital scratch-off game 442 at the time of purchase/play, as discussed herein. The ball call results 458 may be the present ball call or the past ball call. Additionally in non-limiting examples, bingo card pattern 456 and ball call results 458 may be interactive. That is, user 400 can tap or touch bingo card pattern 456 to see the bingo carded assigned to digital scratch-off game 442, as well as the winning pattern or patterns associated with the ball call results of digital scratch-off game 442 (e.g., daubed pattern). Moreover, user 400 can tap or touch ball call results 458 to see the bingo ball call results (e.g., present ball call, past ball call) generated and/or assigned to digital scratch-off game 442. In other non-limiting examples, the bingo ball call results (e.g., present ball call, past ball call) generated and/or assigned to digital scratch-off game 442 may be directly displayed in or adjacent to prize banner 452.

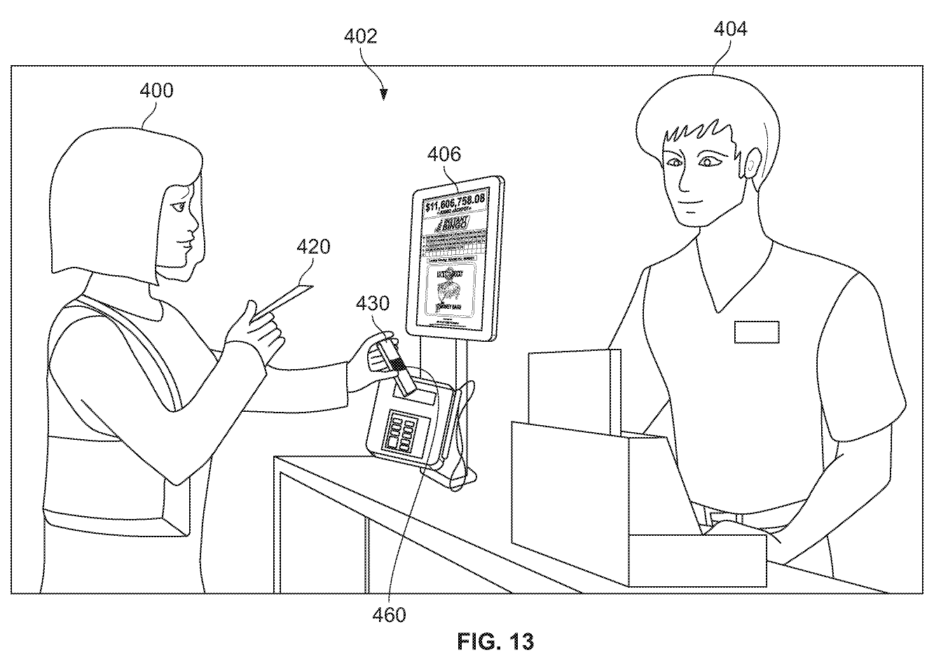

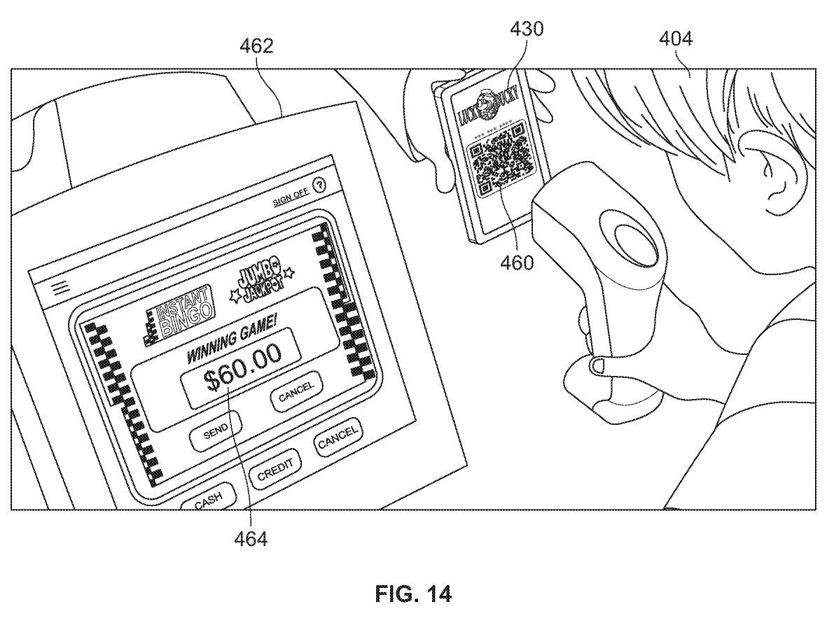

FIGS. 13 and 14 depict user 400 collecting their winnings from digital scratch-off game 442. In the exemplary embodiment, user 400 can return to store 402, or alternatively any participating location of the electronic games and/or places of business where gameplay ticket 420 are sold and collect their winnings from the electronic games associated with gameplay ticket 420. As shown in FIGS. 13 and 14, user 400 can present electronic device 430 to attendant 404 to for confirmation of winning. For example, electronic device 430 can generate and/or display a bar code or QR code 460 for attendant 404 of store 402 to scan (see, FIG. 14) to confirm that user 400 has won prize values from playing digital scratch-off game 442 associated with gameplay ticket 420. Additionally, or alternatively, attendant 404 of store 402 can re-scan gameplay ticket 420 subsequent to playing all the games associated with gameplay ticket 420 (e.g., digital scratch-off game 442) to confirm user 400 is a winner. Attendant 404 may also re-verify that user 400 meets age requirements for playing and winning games associated with gameplay ticket 420 at the time of collection. Upon scanning QR code 460, re-verifying user’s 400 age, and confirming the user 400 has won, a monitor or display 462 for store 402 can display a total prize value 464 to be awarded to user 400. Additionally, or alternatively, physical gameplay ticket 420 can be collected and/or verified by attendant 404 prior to providing user 400 with their winnings.

Although discussed herein as purchasing gameplay ticket 420 at store 402, it is understood that user 400 can purchase gameplay ticket 420 in other locations and/or by other means. For example, and as discussed herein, user 400 can purchase gameplay ticket 420 at a participating gaming facility or casino (see, FIG. 26).

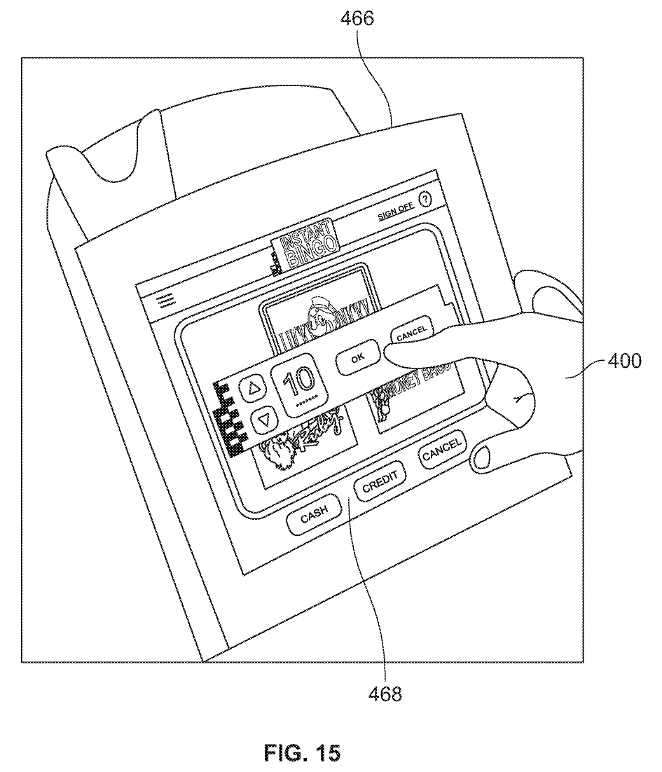

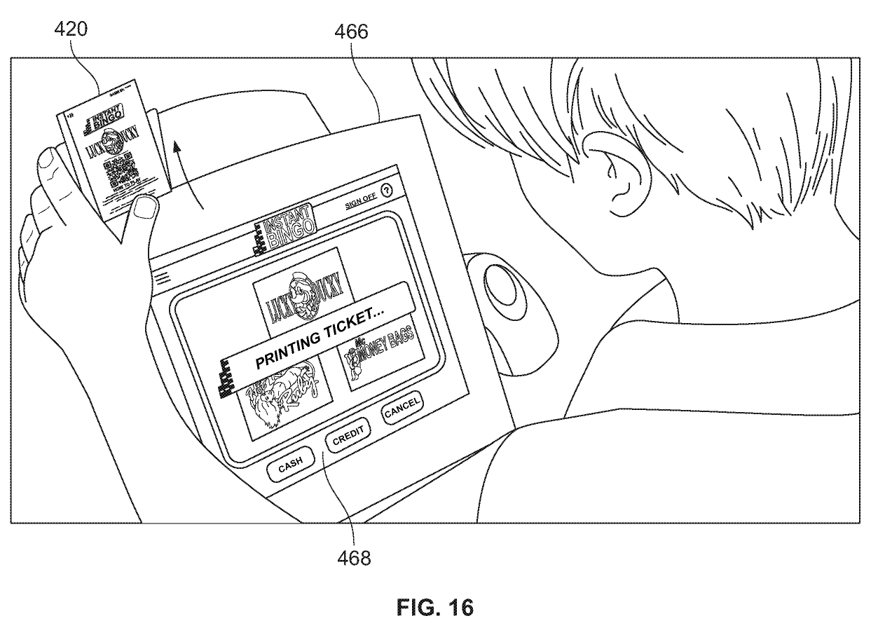

Additionally, user 400 may purchase gameplay ticket 420 from a kiosk 466, as shown in FIGS. 15 and 16. That is, and as shown in exemplary embodiments, user 400 can interact and/or engage kiosk 466 located in a participating gaming facility or store 402 to purchase gameplay ticket 420. Kiosk 466 includes a touch screen 468 that allows user 400 to select from various class II type game titles offered to user 400 (e.g., Lucky Ducky, Hot Red Ruby, Mr. Money Bags) as well as how many games (see, FIG. 15) the user 400 would like to purchase. Once the transaction is complete and finalized (e.g., purchase electronic games), kiosk 466 can print gameplay ticket 420, as shown in FIG. 16, for user 400. User 400 may then follow similar processes discussed herein with respect to FIGS. 7-14 to play and/or collect winnings from games associated with the purchased gameplay ticket 420.

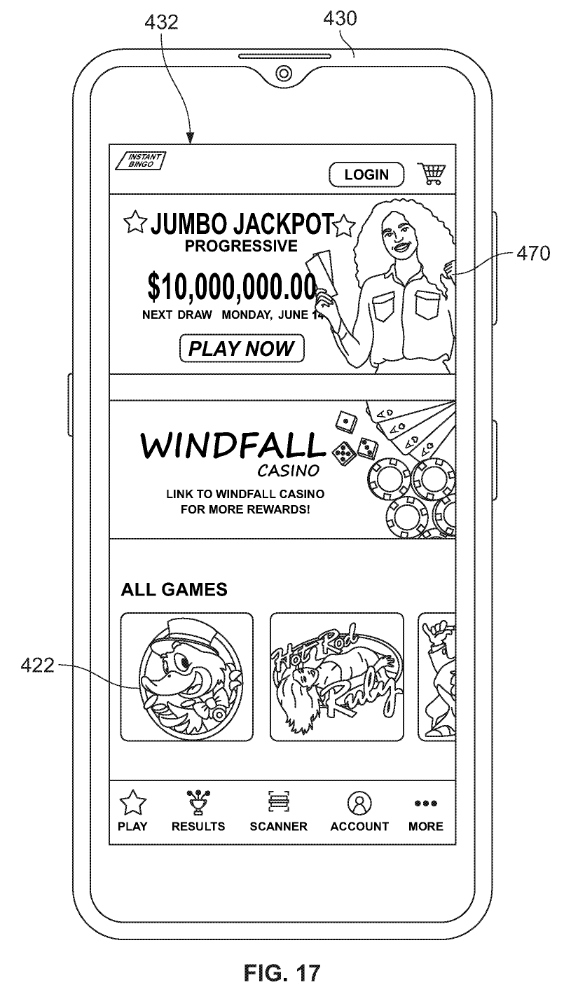

Additionally, user 400 may purchase games directly from app 432. As shown in FIG. 17, user 400 interacts with and/or engages app 432 on electronic device 430 and can purchase games such as digital scratch-off game 442 from app 432. In the non-limiting example, no physical ticket (e.g., gameplay ticket 420) is generated for user 400. Rather, the purchasing of electronic games directly from app 432 can instantaneously download and/or provide games on electronic device 430. User 400 may then follow similar processes discussed herein with respect to FIGS. 8-14 to play and/or collect winnings from games associated with the purchased gameplay ticket 420. Alternatively, user 400 may also purchase games (e.g., digital scratch-off game 442) on a web browser on electronic device 430, and play the purchased games as similarly discussed herein.

App 432 and/or web browser may provide electronic games 442 to user 400 only after identification and/or age verification steps are performed. For example, prior to being able to purchase games and/or scan gameplay ticket 420 using electronic device 430, app 432 requires user 400 to input and confirm identification information including, but not limited to, name, age/birthdate, state of resident, and the like. Alternatively, user 400 may take a picture of their license and upload it to through third party verification software to confirm user 400 is capable of playing the electronic games discussed herein.

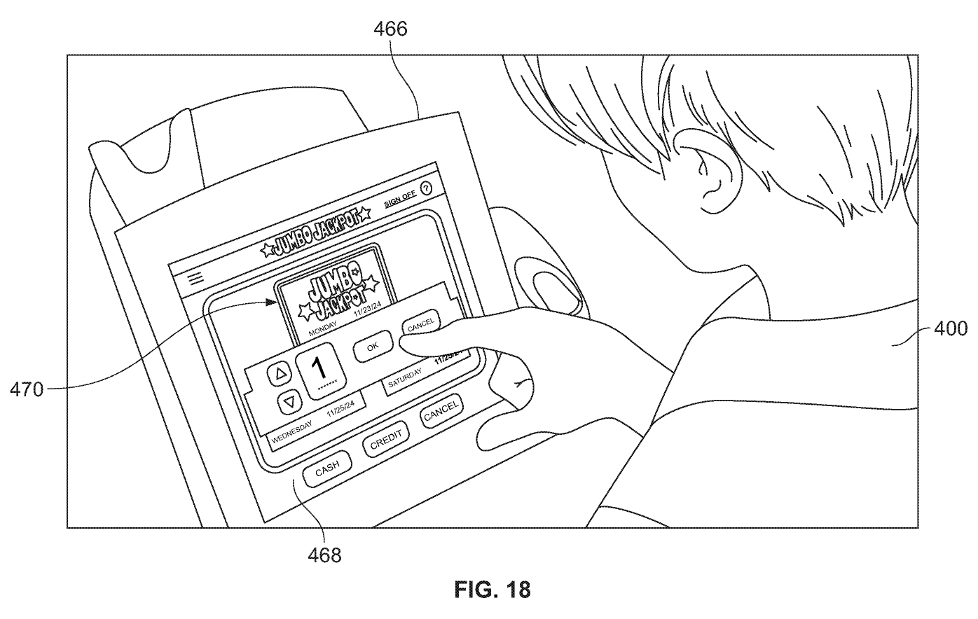

As discussed herein, user 400 can purchase gameplays for a variety of games. In exemplary embodiments, user 400 can purchase gameplays for future games as well. For example, and as shown in FIG. 18, user 400 is using kiosk 466 to purchase a future game 470 (e.g., “Jumbo Jackpot”) in addition to purchase digital scratch-off game 442 (see, FIG. 15). Future game 470 is for a class II style game that will include results to be determined in the future or after the purchase of gameplay ticket 420 including associated future game 470. In one example, gameplay ticket 420 including associated future game 470 may be purchased on a Monday morning, but the results for future game 470 may not be determined until Friday evening. However, at the time of purchase (e.g., Monday morning), the bingo card associated with future game 470 may be assigned and/or linked to gameplay ticket 420.

Purchased gameplay ticket 420 can include and/or link both digital scratch-off game 442 and future game 470 upon being scanned by electronic device 430. That is, a single gameplay ticket 420 is printed for user 400, regardless of how many games user 400 purchased and/or regardless of what types of games (e.g., present or instant games (digital scratch-off game 442), future games 470) user 400 purchased. Additionally, when electronic device 430 scans gameplay ticket 420, all games purchased are linked, loaded, and/or otherwise recognized by app 432 of electronic device 430.

Although discussed herein as purchasing gameplay tickets 420 from kiosk 466 and/or directly within app 432, it is understood that user 400 can purchase games using any other suitable devices and/or method. In exemplary embodiments, digital tickets and/or games can be purchased by scanning an independent QR code not associated with kiosk 466 and/or electronic device 430. In other exemplary embodiments, attendant 404 can scan a QR code associated and/or linked to player’s 400 account on app 432 to link and/or associate a purchased gameplay ticket 420 with user 400 and/or player’s 400 app 432. Similarly, attendant 404 can type in a player code associated and/or linked to player’s 400 account on app 432 to link and/or associate a purchased gameplay ticket 420 with user 400 and/or player’s 400 app 432.

FIGS. 19 and 20 are exemplary embodiments of user 400 playing future games 470 on electronic device 430. That is, and prior to the future time for drawings and/or results of future game 470, electronic device 430 and/or app 432 may provide user 400 with a notification that future game 470 will be played soon. In the non-limiting example shown, future game 470 includes an actual bingo game including a ball call results 472 displayed on user’s 400 distinct electronic device 430A. Future game 470 displayed on electronic device 430 includes the assigned bingo card 474, that is configured to update live based on the ball call results 472 of actual bingo game forming future game 470. As discussed herein, although future game 470 is played at a predetermined, time in the future, future game 470 is a class II style game and/or follows class II style gaming rules.

As shown in FIG. 20, user 400 playing future game 470 is identified as a winner on electronic device 430. For example, assigned bingo card 474 for future game 470 shows user 400 has hit a “4 corners” pattern, and as a result won future game 470. A prize value 476 is also displayed on electronic device 430, under assigned bingo card 474, at the conclusion of future game 470. As similarly discussed herein, user 400 can return to kiosk 466 and/or attendant 404 at store 402 to collect their winnings upon verification of future game 470 (and age verification).

Alternative to collecting prize values from kiosk 466 and/or attendant 404 at store 402, user 400 can also transfer winnings to digital wallets and/or casino-based loyalty cards or clubs. For example, and as shown in FIG. 21, user 400 can transfer prize values and/or winnings from various electronic games associated with gameplay ticket 420 and/or app 432 and transfer the values to a casino-based loyalty wallet 478. In other non-limiting examples, user 400 can transfer funds or prize values directly to a bank account or other financial institution that may be linked to app 432 on electronic device 430.

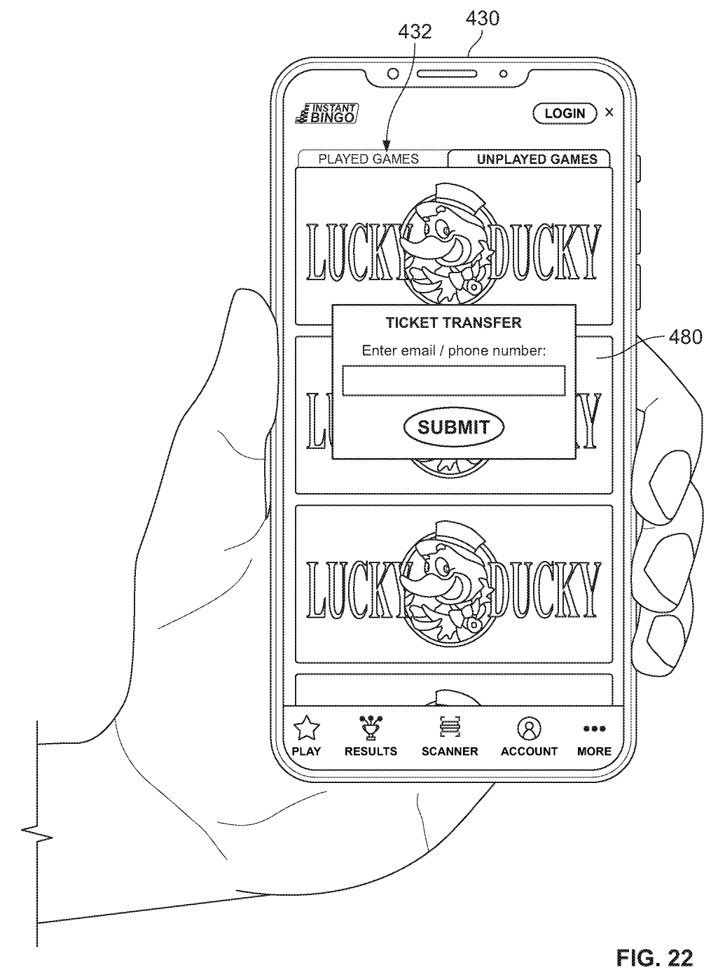

FIG. 22 shows an exemplary screenshot of electronic device 430 where user 400 is initiating the transfer of digital scratch-off games 442 to another person. That is, and subsequent to purchasing digital scratch-off game 442 (e.g., purchase gameplay ticket 420, directly in app 432), user 400 may also transfer digital scratch-off game 442 to another person (e.g., gift). In the non-limiting example, app 432 on electronic device 430 provides an input notification 480 to allow user 400 to provide contact information (e.g., email, phone number) of another person or player they wish transfer digital scratch-off game 442. After entering the contact information in input notification 480, digital scratch-off game 442 are transferred to the designated or receiving user or player. The receiving player may also have an electronic device including app 432 and may have undergone the necessary verification processes as discussed herein. In this example, once transferred from user 400, the receiving player’s app may instantaneously load digital scratch-off game 442 thereon. In other non-limiting examples, whether receiving player has app 432 or is attempting to play digital scratch-off game 442 on a web browser, the receiving player may be required to verify their age and/or location prior to being able to play digital scratch-off game 442 transferred by user 400.

As similarly discussed herein, bingo card(s) and/or ball calls associated with transferred, digital scratch-off game 442 are assigned and/or linked to digital scratch-off game 442 at the time gameplay ticket 420 is purchased by user 400. In another non-limiting example, bingo card(s) and/or ball calls associated with digital scratch-off game 442 are assigned and/or linked to digital scratch-off game 442 at the time when user 400 transfers digital scratch-off game 442 to a receiving player, or when the receiving player engages icons 436 and game instructions 438, and/or play button 440 displayed within app 432 on electronic device 430.

Although discussed herein as being bingo based and/or bingo centric, it is to be understood that the results for electronic games (e.g., digital scratch-off game 442, future game 470) played by users can be determined using any suitable, alternative randomness generators for providing game results. That is, the results of electronic game can be determined by alternative randomness generators, where the results are compared to predetermined or predefined values for each electronic game. In non-limiting examples, the alternative randomness generators can maintain operational requirements for the electronic games to meet either class II type gaming or alternatively class III type gaming.

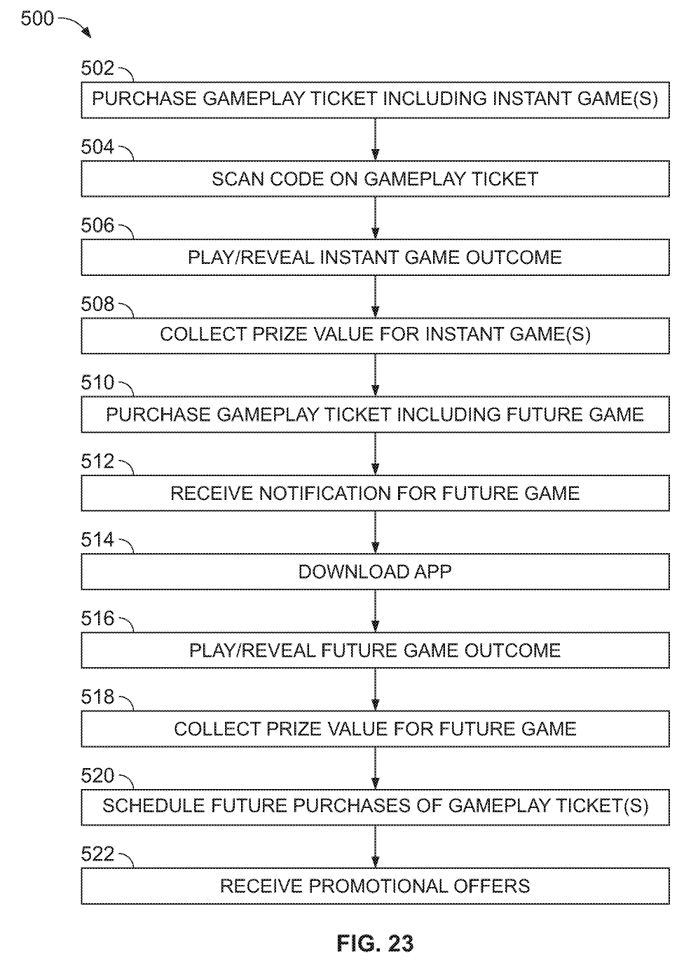

FIG. 23 is a flow diagram showing an exemplary method and/or method 500 of playing various electronic games using electronic device and/or apps, as discussed herein with respect to FIGS. 4-22.

In process 502, a user purchases a gameplay ticket for instant games. For example, a user can enter a participating gas station, brick-and-mortar store, and/or find a kiosk to purchase a gameplay ticket associated with an instant, real-time, and/or present game (e.g., scratch-off game of FIGS. 9-12). In exemplary embodiments, the user can purchase five (5) instant games associated with a single, gameplay ticket from an attendant at a participating gas station.

In process 504, a user can scan a code on the purchased gameplay ticket to launch and/or play the purchased instant game purchased. In exemplary embodiments, the code can include a bar code or a QR code printed on the gameplay ticket purchased by the user. Additionally, a user can use any suitable electronic device, such as a smart phone or tablet, to scan, and subsequently launch the instant game associated with the purchased gameplay ticket. In some examples where the user has downloaded an app associated with the purchased gameplay ticket (e.g., process 512), the scanning of the code in process 504 launches the app and/or loads the purchased instant games into the app. In other examples where the user does not own the app and/or the app is not loaded onto the electronic device used to scan the code, the instant game is loaded in a common app on the electronic device, for example a web browser.

In process 506, the user plays and/or interacts with instant game associated with the purchased gameplay ticket to reveal the instant game outcome. More specifically, the user can interact with instant game using the electronic device to play and/or reveal an outcome for the instant game.

In response to determining the instant game is a winner, a credit, cash, and/or prize value is awarded to the user. In process 508, the user can collect the prize value awarded in and/or by the instant games. In exemplary embodiments, the user can be awarded $10.00 as a result of revealing the outcomes of the purchased and played instant games. The user can return to the gas station, for example, or any other participating location to collect the prize value awarded by the instant games. In another non-limiting example, the player can load or save the winnings in a gameplay app or a digital wallet linked to a bank account using the electronic device used to play the instant game (e.g., process 506).

In process 510, the user can take the awarded or collected prize value from the instant game and purchase an additional gameplay ticket and/or additional games. In an exemplary embodiment, the user purchases a gameplay ticket including five (5) tickets or plays for a future game. In the example where the user returns to the gas station to collect their prize value (e.g., process 508), the user can purchase a separate or distinct gameplay ticket from the attendant at the gas station. Alternatively, the user can purchase the five (5) tickets or plays of the future game using the electronic device and/or the app (e.g., in-app purchase) in which the user utilized to play the instant games (e.g., process 506).

In process 512, the user receives a notification including information regarding the future game. For example, subsequent to purchasing the five (5) plays for a future game on the electronic device, the app and/or the electronic device may be provided with a notification notifying the user that the future game will be played on a future date and/or future time (e.g., “Thursday, 5:00 PM EST”). Moreover, the notification in process 512 can also identify where winning tickets and/or gameplays for the future game can be redeemed (e.g., participating stores, in-app redemption).

In process 514, the user can download an app relating to and/or associated with the purchased gameplay tickets and/or the instant/future games. That is, and where the user does not already have the app downloaded when playing the instant game (e.g., processes 502-508), the user can subsequently download the app to the electronic device utilized to play the instant game and/or purchase the future game plays or tickets. Additionally by downloading the app, the user is eligible to earn loyalty and/or rewards points based on, for example, large purchases, constant purchases, and/or promotional offers based on app use. Additionally, or concurrently to downloading the app, the purchased games or plays for the future game (e.g., process 510) can be linked to the downloaded app and/or the user’s account established in the app. In an exemplary embodiment, the app can link the purchased games for the future game using information or data from and/or stored on the electronic device used to purchase the future games. In other exemplary embodiments where the user purchases distinct gameplay ticket, the user can scan a code (bar code, QR code) on the purchased gameplay ticket after downloading the app. Once scanned, the app can link the purchased games for the future games to the user’s account based on the scanning of the code.

In process 516, the outcome of the future game can be played and/or revealed. The outcome of the future game is revealed at the future, predetermined time (e.g., “Thursday, 5:00 PM EST”). Using the app and/or the electronic device, the user can watch, play, and/or reveal the outcome in real-time. For example, where the future game is a live bingo game or event, the user can watch the live ball call on the app/electronic device. Where the user is a winner of the future game, the app and/or electronic device can provide the user with a notification including a prize value to be awarded.

In process 518, and in response to determining the future game is a winner, a credit, cash, and/or prize value is awarded to the user. In process 518, the user can collect the prize value awarded in and/or by the future game. In exemplary embodiments, the user can be awarded $50.00 as a result of revealing the outcomes of the purchased and played future game. The user can return to the gas station, for example, or any other participating location to collect the prize value awarded by the instant games. In other exemplary embodiments, the player can load or save the winnings in a gameplay app or a digital wallet linked to a bank account using the electronic device.

In process 520, the user can schedule future purchases of gameplay ticket(s). In exemplary embodiments, the user can opt to sign-up and/or schedule to buy five (5) gameplay tickets on a weekly basis using the app and/or the electronic device. As such, and so long as certain conditions are met (e.g., location of the user), gameplay tickets can be purchased and linked to the user’s app on a weekly basis until the user opts out and/or changes the frequency in which gameplay tickets are purchased.

In process 522, and as a result of playing games and/or using the app, the user can also receive promotional offers. In exemplary embodiments, the user can receive promotional offers within the app and/or on the electronic device, and be provided a notification relating to such promotional offers. In one example, the user can receive a promotional offer including a “2-for-1” instant game deal, where the purchase of a single play of the instant game results in the providing and/or ability to play two instant games.

Although discussed in a certain order, it is understood that at least a portion of the processes 502-522 of the method 500 discussed herein can be performed in distinct orders and/or concurrently to one another. For example, the user can wait to redeem or collect the prize values associated with the instant game(s) and/or future games (e.g., processes 508, 518) at any time subsequent to the playing of the games and/or the revealing of the respective outcomes.

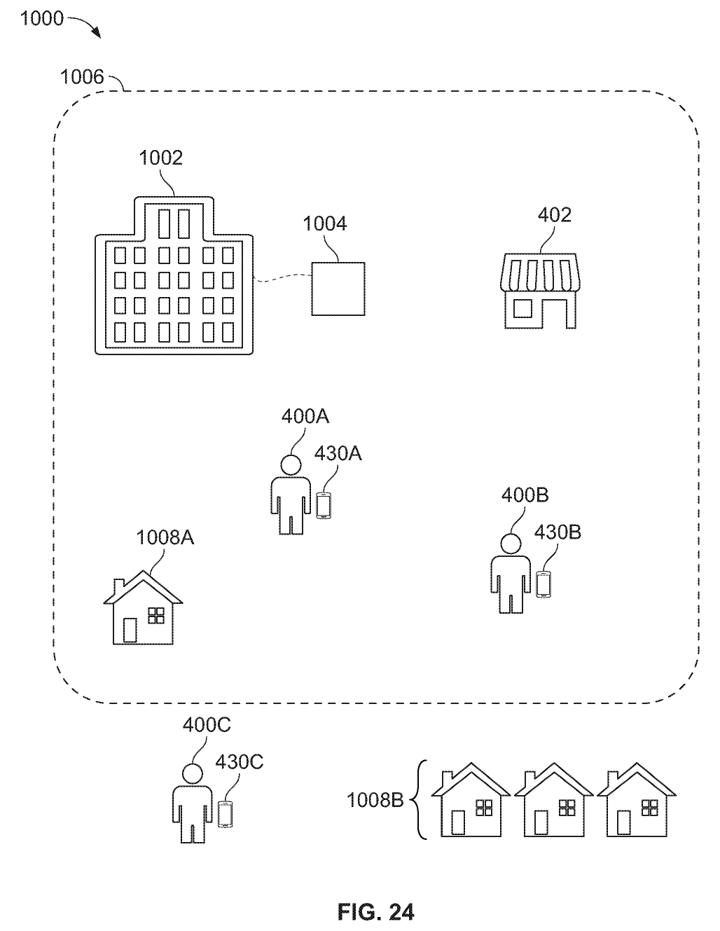

Additionally, and as discussed herein, certain processes 502-522 of method 500 can be restricted based on characteristics of the user. For example, and as discussed herein, gameplay tickets may only be purchased (e.g., processes 502, 510), prize values may only be collected (e.g., processes 508, 518), and/or game outcomes may only be revealed (e.g., processes 506, 516) when a user is located in a predetermined geolocation or area (e.g., participating tribal lands). Additionally, other processes, such as downloading the app (e.g., process 514) and/or receiving promotional offerings (e.g., process 522) can take place and/or occur at any time and/or without any restrictions based on characteristics of the user (e.g., geolocation). Additionally exemplary embodiments are discussed in detail herein with respect to the environment shown in FIGS. 24-27.

### Environment Overview

FIG. 24 shows an exemplary schematic view of an environment 1000 that implements the electronic games and gameplays discussed herein with respect to FIGS. 4-23. It is to be understood that similarly numbered and/or named components may function in a substantially similar fashion. Redundant explanation of these components has been omitted for clarity.

As shown in FIG. 24, environment 1000 includes multiple users 400A-400C and associated electronic devices 430A-430C as well as store 402. Additionally, environment 1000 includes a gaming facility or casino 1002 (hereafter, “casino 1002”), and computing system and/or server 1004 (hereafter, “server 1004”) in communication with casino 1002. Server 1004 includes any suitable computing device, computing system, and/or computing server(s) that is configured to operate electronic games (e.g., digital scratch-off game 442, future game 470) as discussed herein. Additionally, server 1004 is in communication with and/or included within casino 1002, as casino 1002 represents the responsible party or entity for controlling operation and/or monitoring the electronic games run by server 1004.

Environment 1000 also includes a predefined geofence 1006 substantially surrounding casino 1002. That is, and as shown in FIG. 24, geofence 1006 defines an area surrounding casino 1002, and other buildings or locations adjacent casino 1002, in which electronic games provided by server 1004 may be played, purchased, and/or collected. In a non-limiting example, geofence 1006 may be configurable to define an area of tribal land that includes casino 1002 owned and operated by a designated tribe of the area. In non-limiting example, users 400A, 400B and/or players located in house 1008A within geofence 1006 of environment 1000 may be allowed and/or authorized to purchase gameplay tickets 420, as well as play, transfer, and collect on games associated with gameplay ticket 420. As discussed herein, user 400A, 400B may collect prize values from participating locations including store 402 located within predefined geofence 1006, directly from casino 1002, and/or a kiosk 466 (not shown) located in casino 1002 or store 402, and/or within geofence 1006. Alternatively, user 404C and/or players located houses 1008B located outside of geofence 1006 may be prevented from at least one of purchasing gameplay ticket 420 via app 432 on electronic device 430C, playing games on electronic device 430C, collecting prize values from games associated with gameplay ticket 420, and/or transferring gameplay ticket 420 to another player or user.

Server 1004 and/or telecommunication systems included within casino 1002 may define geofence 1006 area. Additionally in non-limiting examples, app 432 and/or electronic devices 430A-430C has geolocation features (e.g., GPS tracking) enabled during use operation to monitor and/or determine if user 400A-400C is located within predefined geofence 1006. As discussed herein, the location of users 400A-400C and/or electronic device 430A-430C used to play the electronic games administered by server 1004 may affect and/or determine what actions, if any, user 400A-400C can take while attempting to purchase, play, transfer, and/or collect on the electronic games.

### Environment Alternatives

As discussed herein, actions which users 400A-400C can take relating to electronic games played within environment 1000 and/or controlled by server 1004 are dependent, at least in part, on users 400A-400C location with respect to geofence 1006. For example, users 400A, 400B and/or players in house 1008A can purchase gameplay ticket 420, play electronic games (e.g., digital scratch-off game 442, future game 470) associated with gameplay ticket 420, collect awarded prizes from the electronic games, transfer funds to bank accounts and/or casino loyal-club programs, and transfer electronic games to other users also located within geofence 1006. Alternatively, user 404C and/or players in houses 1008B located outside of geofence 1006 may be prevented from at least one of purchasing gameplay ticket 420 via app 432 on electronic device 430C, playing games on electronic device 430C, collecting prize values from games associated with gameplay ticket 420, and/or transferring gameplay ticket 420 to another player or user. Additionally, stores outside of geofence 1006 (not shown) are not participating stores in the electronic games discussed herein, and therefore cannot sell gameplay ticket 420.

In other non-limiting examples, at least some of the actions relating to the electronic games controlled by server 1004 can be performed outside of geofence 1006. For example, user 400A located in geofence 1006 may be permitted to transfer electronic games (e.g., digital scratch-off game 442, future game 470) associated with gameplay ticket 420 to any receiving user, regardless of whether the receiving user is located within geofence 1006 or not. In the non-limiting example, it is required, however, that user 400A be located within geofence 1006 when transferring the electronic games via app 432, as discussed herein.

Moreover, user 400C located outside of geofence 1006 may not be permitted to purchase gameplay ticket 420 but may be permitted to play the electronic games associated with gameplay ticket 420 outside of geofence 1006. In this example, user 400C may have previously purchased gameplay ticket 420 (and subsequently scanned gameplay ticket 420) while located within geofence 1006, but then left geofence 1006 area before playing the electronic games.

Alternatively, user 400C who may not be permitted to purchase gameplay ticket 420 or play the electronic games associated with gameplay ticket 420 outside of geofence 1006 may be permitted to transfer awarded prize values while outside of geofence 1006. The transferrable prize values may have been previously won by user 400C while playing electronic games associated with gameplay ticket 420 while located within geofence 1006.

In another example, user 400C may only be permitted to transfer the electronic games (e.g., digital scratch-off game 442, future game 470) using app 432 to another user when user 400C is outside geofence 1006. In one example, the receiving user (e.g., user 400A) must be located within geofence 1006 to receive the electronic games. In another example, user 400C can transfer the electronic games to a receiving user regardless of whether the receiving user is located within geofence 1006 or not.

Additionally, when it comes to transferring awarded prize values and/or electronic games associated with gameplay ticket 420, location of each party or user may determine what transfers are permissible. For example, user 400A located within geofence 1006 may be permitted to transfer electronic games to user 400C who is positioned outside of geofence 1006. However, user 400C located outside of geofence 1006 may not be permitted to transfer electronic games to user 400A who is positioned inside of geofence 1006.

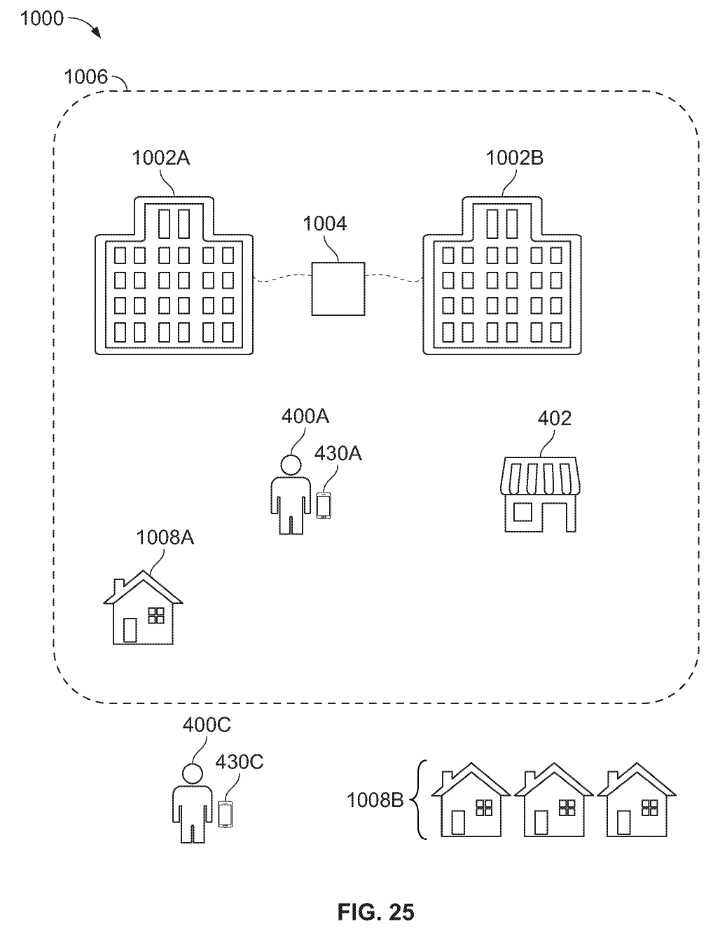

FIG. 25 is an illustrative example of another environment 1000 in which electronic games controlled by server 1004 are played. In the non-limiting example, environment 1000 includes two distinct casinos 1002A, 1002B. Each of the two distinct casinos 1002A, 1002B are positioned within a single geofence 1006. Additionally, each of the two distinct casinos 1002A, 1002B are in electronic communication with server 1004. As such, both casinos 1002A, 1002B, as well as store 402, are participants of the electronic games controlled by server 1004. As such, user 400A located within geofence 1006 can purchase gameplay ticket 420 from either casino 1002A, 1002B, as well as store 402 and/or on app 432 for electronic device 430A. Furthermore, any jackpot included in the electronic games controlled by server 1004 may be progressive jackpots as a result of both casinos 1002A, 1002B being connected to server 1004 and/or both casinos 1002A, 1002B participating in the electronic gaming discussed herein.

Additionally in the non-limiting example, user 400A is free to perform distinct actions relating to the electronic games in different, participating locations. For example, user 400A can purchase gameplay ticket 420 at first casino 1004A, and subsequently play the electronic games (e.g., digital scratch-off game 442) anywhere within geofence 1006. User 400A can subsequently collect prize values awarded by the electronic games from second casino 1002B. In this example, casinos 1002A, 1002B may partner and/or share information and funds only relating to the electronic games controlled by server 1004.

In other non-limiting examples where more than one casino 1002A, 1002B participate in the electronic games controlled by server 1004, a central or third party entity may be solely responsible for paying winning users 400. That is, in addition to casinos 1002A, 1002B, a third party entity (not shown) located within geofence 1006 may also be in electronic communication with server 1004. The third party entity may collect funds from each of casinos 1002A, 1002B relating to the electronic games discussed herein, and also may be solely responsible for providing awarded prize values to users 400 located within geofence 1006. As such, user 400A may purchase gameplay ticket 420 at either casinos 1002A, 1002B, and may subsequently play the electronic games associated with gameplay ticket 420. However, in the non-limiting example, user 400A may only collect the award prize values from playing the electronic games from the third party entity within geofence 1006.

Additionally, or alternatively, the third party entity may be responsible for payouts and/or awarding prize values to players 400A-400C over a predetermined amount. That is, players 400A-400C winning prize values below a predetermined threshold may collect the awarded prize values from either casino 1002A, 1002B, or the third party entity. However, players 400A-400C wining prize values equal to or over the predetermined threshold may only be able to collect the awarded prize value from the third party entity.

In exemplary embodiments, casinos 1002A, 1002B located within geofence 1006 are owned and/or operated by distinct operators, companies, and/or business entities. In another example, casinos 1002A, 1002B located within shared geofence 1006 may be owned and/or operated by the same operator, company, and/or business entity. As discussed herein, the progressive jackpot is shared and/or contributed to by each of the distinct casinos 1002A, 1002B regardless of ownership.

FIG. 26 is an illustrative example of an additional environment 1000 in which electronic games controlled by server 1004 are played. As shown, environment 1000 includes two distinct casinos 1002A, 1002B; each positioned within distinct geofences 1006A, 1006B. That is, first geofence 1006A includes first casino 1002A (and server 1004), while second, distinct geofence 1006B includes second casino 1002B. Similar to environment 1000 shown in FIG. 25, each of the two distinct casinos 1002A, 1002B are in electronic communication with server 1004. As such, both casinos 1002A, 1002B, as well as store 402 located in first geofence 1006A, are participants of the electronic games controlled by server 1004.

Distinct geofences 1006A, 1006B of environment 1000 may determine which actions relating to the electronic gaming controlled by server 1004 are permissible by users 400A, 400B within each geofence 1006A, 1006B. For example, it may be permissible for user 400A to purchase gameplay ticket 420 in casino 1002A or store 402, and subsequently play in either geofence 1006A, 1006B, transfer electronic games to users within either geofence 1006A, 1006B, and/or collect awarded prize values in casino 1002A, store 402, and/or casino 1002B. However, user 400B located within second geofence 1006B may be permitted to purchase gameplay ticket 420 in casino 1002B, but only permitted to play when located within geofence 1006B, transfer electronic games to users within geofence 1006B, and/or collect awarded prize values in casino 1002B. Furthermore, user 400A may be permitted to transfer the electronic games associated with the purchased, gameplay ticket 420 to user 400C outside of both geofences 1006A, 1006B, while user 400B can only transfer electronic games to users located within geofence 1006B.

Similar to the non-limiting example discussed herein with respect to FIG. 25, any jackpot included in the electronic games controlled by server 1004 may be progressive jackpots as a result of both casinos 1002A, 1002B being connected to server 1004 and/or both casinos 1002A, 1002B participating in the electronic gaming discussed herein. Furthermore, where more than one casino 1002A, 1002B participates in the electronic games controlled by server 1004, a central or third party entity (not shown) may be solely responsible for receiving funds from purchased gameplay tickets 420 and/or paying winning users 400.

In exemplary embodiments, geofences 1006A, 1006B may define two distinct tribal lands, wherein casinos 1002A, 1002B are owned and/or operated by distinct operators, companies, and/or business entities. In the exemplary embodiments, each tribal land including geofences 1006A, 1006B are either located in the same state or region or can be located in distinct states or regions of a country (e.g., distinct states of the United States). In yet another example, casinos 1002A, 1002B located within distinct geofences 1006A, 1006B may be owned and/or operated by the same operator, company, and/or business entity. As discussed herein, the progressive jackpot is shared and/or contributed to by each of the distinct casinos 1002A, 1002B regardless of location and/or ownership.

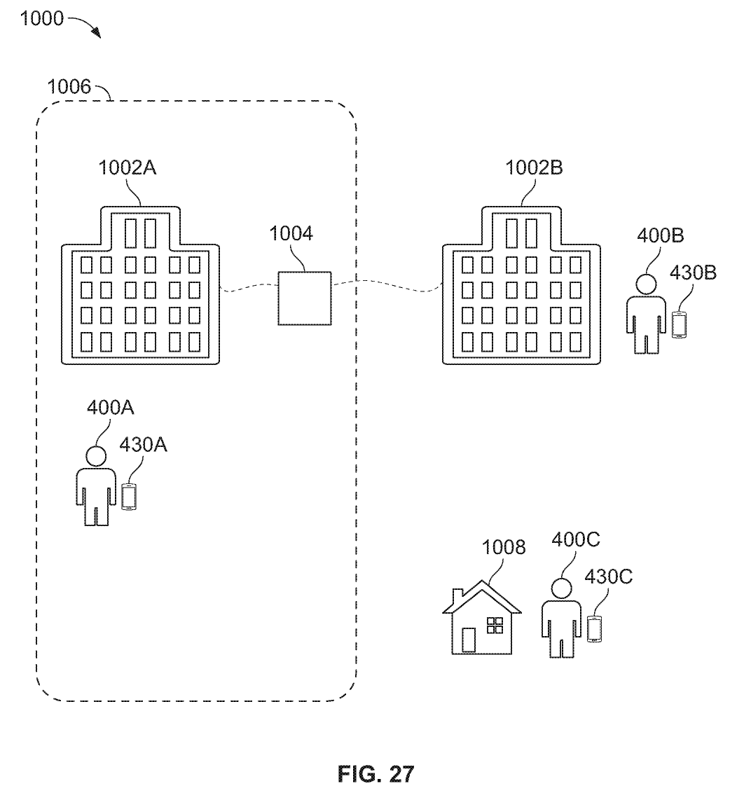

FIG. 27 is another illustrative example of environment 1000 in which electronic games controlled by server 1004 are played. In the non-limiting example, geofence 1006 substantially surrounds casino 1002A and server 1004. Additionally, user 400A may be located within geofence 1006. As discussed herein, geofence 1006 of FIG. 27 may define tribal land in which electronic games controlled by server 1004 may be played.

Casino 1002B is not surrounded by any geofence and may include a casino or gaming facility in a distinct area where all gaming is permitted. For example, casino 1002B may be located in Las Vegas, NV or within the country of Monaco. With distinct gaming laws and/or regulations, users 400B located within the country of Monaco may be able purchase gameplay ticket 420, play associated electronic games, collect awarded prize values, and/or transfer awarded prize values/ electronic games free of the limitations imposed by geofence 1006, as similarly discussed herein.

As discussed herein, casinos 1002A, 1002B are located within distinct areas and/or states of the United States. In exemplary embodiments, casinos 1002A, 1002B of environment 1000 shown in FIG. 27 are owned and/or operated by distinct operators, companies, and/or business entities. In another example, casinos 1002A, 1002B may be owned and/or operated by the same operator, company, and/or business entity. As discussed herein, the progressive jackpot is shared and/or contributed to by each of the distinct casinos 1002A, 1002B regardless of ownership.

Additionally, user 400C may live in house 1008 in another distinct area or jurisdiction than casinos 1002A, 1002B. For example, user 400C may live in Madrid, Spain. Based on local laws and regulations, and similar to user 400B visiting casino 1002B, user 400C located in Spain may be permitted to purchase gameplay ticket 420, play associated electronic games, collect awarded prize values, and/or transfer awarded prize values/ electronic games free of the limitations imposed by geofence 1006, as similarly discussed herein. Moreover, in non-limiting examples, users 400B, 400C outside of geofence 1006 may be permitted to transfer electronic games to one another but may not be permitted to transfer electronic games to user 400A located within geofence 1006. The converse may be truth as well, where user 400A is permitted to only transfer electronic games to other users located within geofence 1006 but may not be permitted to transfer electronic games to users 400B, 400C.

As discussed herein, the jackpot included in the electronic games controlled by server 1004 for environment 1000 shown in FIG. 27 may be a progressive, global jackpot. The global jackpot is based on both casinos 1002A, 1002B being connected to server 1004 and/or both casinos 1002A, 1002B participating in the electronic gaming, as well as user’s 400C ability to play electronic games in their home country. Furthermore, and as similarly discussed herein, a central or third party entity (not shown) of environment 1000 shown in FIG. 27 may be solely responsible for receiving funds from purchased gameplay tickets 420 and/or paying winning users 400.

Additionally, it is understood that jackpots discussed herein, for example, include Omnichannel Wide Area Progressive (WAP) jackpots. For example, the progressive, global jackpot discussed herein with reference to FIG. 27 is a WAP jackpot where all participating locations (e.g., casino 1002A, 1002B) and/or players (e.g., user 400A, 400C) all contribute toward and/or are all playing for a single jackpot. Moreover, a variety of types of games at each of the locations and/or played by each of players contribute and/or participate in the progressive jackpot. For example, user 400A within geofence 1006 can play a class II type game at casino 1002A, as similarly discussed herein, while user 400B can play a glass III type game at casino 1002B, and user 400C can play a land-based and/or online (e.g., electronic) game type. In the exemplary embodiment, each of user 400A, 400B, 400C are participating, contributing, and/or vying for the progressive jackpot shared between the locations/players, regardless of the type of games they are playing – so long as players 400A, 400B, 400C are playing participating games.

Although various examples of actions permissible and impermissible for users 400A-400C with respect to the electronic games controlled by server 1004 are discussed herein, it is to be understood that any combination of actions may be permissible/impermissible based on the location of users 400A-400C with respect to geofence(s) 1006. What actions may be permissible/impermissible for users 400A-400C may be dependent upon, at least in part, tribal laws, state laws, and/or federal laws governing gaming, prize awards, and/or bank/money transfers.

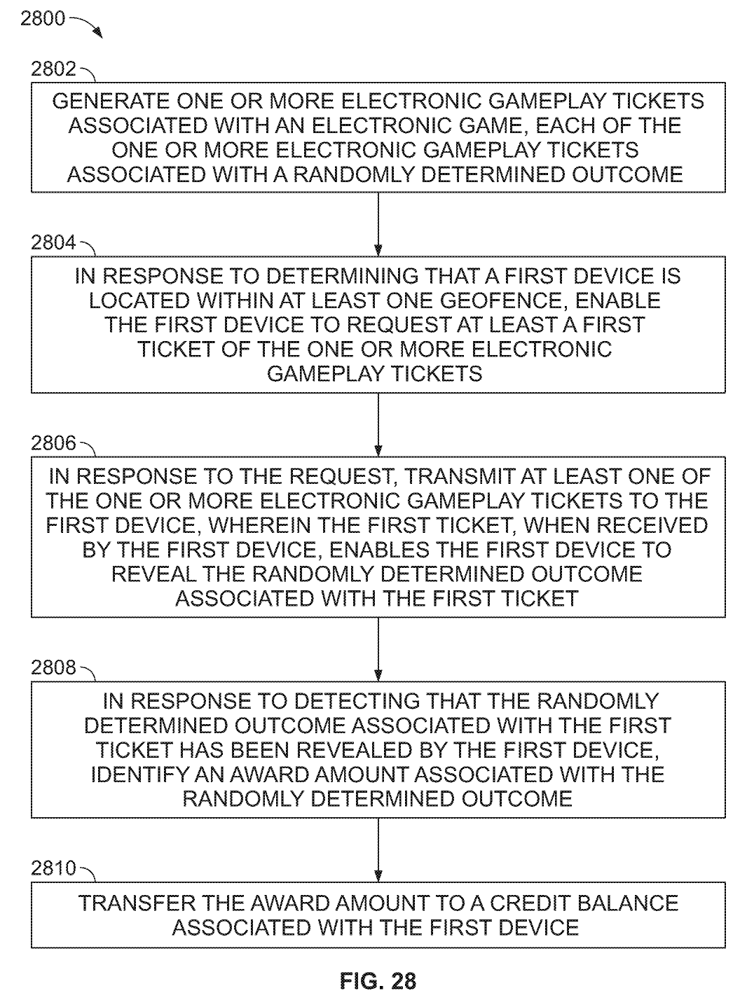

FIG. 28 is a flowchart illustrating an exemplary method 2800 for electronic gaming using geofencing and electronic gameplay tickets. Method 2800 may be performed, for example, by server 1004 operating within environment 1000 (shown in FIGS. 24-28.

Method 2800 may include generating (block 2802) one or more electronic gameplay tickets associated with an electronic game. Each of the one or more electronic gameplay tickets includes a specific, predefined data structure and may be associated with and/or include a randomly determined outcome. The outcome associated with each of the electronic gameplay tickets may be determined using any of the random determination methods described herein. For example, in some embodiments, server 1004 may determine the randomly determined outcome for each electronic gameplay ticket by assigning a respective electronic bingo card to each of the electronic gameplay tickets and comparing the electronic bingo card assigned to each of the electronic gameplay tickets to a randomly generated ball call.

Method 2800 may further include, in response to determining that a first device (e.g., a mobile device such as electronic device 430) is located within at least one geofence (e.g., geofence 1006), enabling (block 2804) the first device to request at least a first ticket of the one or more electronic gameplay tickets. In certain embodiments, geolocation data (e.g., GPS data) generated by sensors of and received from the first device may be used to monitor a location of the first device and determine whether the first device is currently within the geofence. In some embodiments, if the first device is located within the geofence, the first ticket may be electronically purchased directly using the first device (e.g., via an app executing on the first device. Additionally, or alternatively, a point of sale device within the geofence may be used to print a physical ticket associated with the first ticket and, the first ticket may be transferred to the first device in response to the first device scanning the physical ticket. In cases in which the point of sale device is associated with a particular casino and/or tribal jurisdiction, the geofence may be determined based on the casino associated with the point of sale device.

Method 2800 may further include, in response to the request, transmitting (block 2806) at least one of the one or more electronic gameplay tickets to the first device, wherein the first ticket, when received by the first device, enables the first device to reveal the randomly determined outcome associated with the first ticket. In some cases, the randomly determined outcome is not initially presented, and is only revealed in response to user input and/or satisfaction of other predetermined conditions, such as a certain amount of time elapsing. For example, in some embodiments, server 1004 causes the randomly determined outcomes associated with all the electronic tickets of a particular electronic game to be revealed substantially simultaneously. In some embodiments, the first ticket enables the first device to reveal the randomly determined outcome when the first device is located within the geofence or outside the geofence. Alternatively, the first ticket may enable the first device to reveal the randomly determined outcome only when the first device is located within the geofence.

Method 2800 may further include, in response to detecting that the randomly determined outcome associated with the first ticket has been revealed by the first device, identifying (block 2808) an award amount associated with the randomly determined outcome and transferring (block 2810) the award amount to a credit balance associated with the first device. In some embodiments, the award amount may be transferred to the credit balance associated with the first device when the first device is located within the at least one geofence or outside the at least one geofence. Alternatively, the award amount may be transferred to the credit balance associated with the first device when the first device is outcome only when the first device is located within the at least one geofence.

In certain embodiments, the first ticket is configured to be transferred from the first device to a second device. Once transferred, the first ticket enables the second device to reveal the randomly determined outcome associated with the first ticket, and any awards associated with this outcome may be transferred to a credit balance associated with the second device. In some embodiments, the first ticket may be configured to be transferable from the first device to the second device when either of the first device and the second device are located within the at least one geofence or outside the at least one geofence. Alternatively, the first ticket may be configured to be transferable from the first device to the second device only when both the first device and the second device are located within the at least one geofence.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising at least one memory and at least one processor in communication with the at least one memory, the at least one memory storing geofence data defining at least one geofence, the at least one processor programmed to:
generate one or more electronic gameplay tickets associated with an electronic game, each of the one or more electronic gameplay tickets associated with a randomly determined outcome;
in response to determining that a first device is located within the at least one geofence, enable the first device to request at least a first ticket of the one or more electronic gameplay tickets;
in response to the request, transmit at least one of the one or more electronic gameplay tickets to the first device, wherein the first ticket, when received by the first device, enables the first device to reveal the randomly determined outcome associated with the first ticket;
in response to detecting that the randomly determined outcome associated with the first ticket has been revealed by the first device, identify an award amount associated with the randomly determined outcome; and
transfer the award amount to a credit balance associated with the first device.

2. The electronic gaming system of claim 1, wherein the first device is a mobile device.

3. The electronic gaming system of claim 1, wherein the first ticket enables the first device to reveal the randomly determined outcome when the first device is located within the at least one geofence or outside the at least one geofence.

4. The electronic gaming system of claim 1, wherein the first ticket enables the first device to reveal the randomly determined outcome only when the first device is located within the at least one geofence.

5. The electronic gaming system of claim 1, wherein the at least one processor is further programmed to transfer the award amount to the credit balance associated with the first device when the first device is located within the at least one geofence or outside the at least one geofence.

6. The electronic gaming system of claim 1, wherein the at least one processor is further programmed to transfer the award amount to the credit balance associated with the first device when the first device is outcome only when the first device is located within the at least one geofence.

7. The electronic gaming system of claim 1, wherein the first ticket is configured to be transferred from the first device to a second device, wherein the first ticket, when transferred to the second device, enables the second device to reveal the randomly determined outcome associated with the first ticket.

8. The electronic gaming system of claim 7, wherein the first ticket is configured to be transferable from the first device to the second device when either of the first device and the second device are located within the at least one geofence or outside the at least one geofence.

9. The electronic gaming system of claim 7, wherein the first ticket is configured to be transferable from the first device to the second device only when both the first device and the second device are located within the at least one geofence.

10. The electronic gaming system of claim 1, wherein the at least one processor is further programmed to determine the randomly determined outcome for each of the one or more electronic gameplay tickets by assigning an electronic bingo card to each of the one or more electronic gameplay tickets and comparing the electronic bingo card assigned to each of the one or more electronic gameplay tickets to a randomly generated ball call.

11. The electronic gaming system of claim 1, wherein the at least one processor is further configured to:
cause a point of sale device to print a physical ticket associated with the first ticket; and
in response to detecting the first device scanning the physical ticket, transfer the first ticket to the first device.

12. The electronic gaming system of claim 11, wherein the point of sale device is associated with a casino, and wherein the at least one geofence associated with the first ticket is determined based on the casino associated with the point of sale device.

13. The electronic gaming system of claim 1, wherein the at least one processor is further programmed to determine that the first device is located within the at least one geofence based on geolocation data received from the first device.

14. A method for electronic gaming, the method performed by a system including at least one memory and at least one processor in communication with the at least one memory, the at least one memory storing geofence data defining at least one geofence, the method comprising:
generating one or more electronic gameplay tickets associated with an electronic game, each of the one or more electronic gameplay tickets associated with a randomly determined outcome;
in response to determining that a first device is located within the at least one geofence, enabling the first device to request at least a first ticket of the one or more electronic gameplay tickets;
in response to the request, transmitting at least one of the one or more electronic gameplay tickets to the first device, wherein the first ticket, when received by the first device, enables the first device to reveal the randomly determined outcome associated with the first ticket;
in response to detecting that the randomly determined outcome associated with the first ticket has been revealed by the first device, identifying an award amount associated with the randomly determined outcome; and
transferring the award amount to a credit balance associated with the first device.

15. The method of claim 14, wherein the first device is a mobile device.

16. The method of claim 14, wherein the first ticket enables the first device to reveal the randomly determined outcome when the first device is located within the at least one geofence or outside the at least one geofence.

17. The method of claim 14, wherein the first ticket enables the first device to reveal the randomly determined outcome only when the first device is located within the at least one geofence.

18. The method of claim 14, wherein the at least one processor is further programmed to transfer the award amount to the credit balance associated with the first device when the first device is located within the at least one geofence or outside the at least one geofence.

19. The method of claim 14, wherein the at least one processor is further programmed to transfer the award amount to the credit balance associated with the first device when the first device is outcome only when the first device is located within the at least one geofence.

20. At least one non-transitory computer-readable storage media having computer-executable instructions embodied thereon, wherein when executed by at least one processor in communication with at least one memory, the at least one memory storing geofence data defining at least one geofence, the computer-executable instructions cause the at least one processor to:
generate one or more electronic gameplay tickets associated with an electronic game, each of the one or more electronic gameplay tickets associated with a randomly determined outcome;
in response to determining that a first device is located within the at least one geofence, enable the first device to request at least a first ticket of the one or more electronic gameplay tickets;
in response to the request, transmit at least one of the one or more electronic gameplay tickets to the first device, wherein the first ticket, when received by the first device, enables the first device to reveal the randomly determined outcome associated with the first ticket;
in response to detecting that the randomly determined outcome associated with the first ticket has been revealed by the first device, identify an award amount associated with the randomly determined outcome; and
transfer the award amount to a credit balance associated with the first device.
